(19) United States
(12) Patent Application Publication
(10) Pub. No.: US 2021/0073026 A1
(43) Pub. Date: Mar. 11, 2021

(54) VALIDATING AND PUBLISHING COMPUTING WORKFLOWS FROM REMOTE ENVIRONMENTS

(71) Applicant: MicroStrategy Incorporated, Vienna, VA (US)

(72) Inventors: Clayton Myers, Oak Hill, VA (US); Andrew Smith, Oakton, VA (US); Richard Gardner, Leesburg, VA (US); Timothy Lang, McLean, VA (US)

(21) Appl. No.: 17/013,005

(22) Filed: Sep. 4, 2020

Related U.S. Application Data
(60) Provisional application No. 62/896,217, filed on Sep. 5, 2019.

(51) Int. Cl. G06F 9/48; G06F 11/34

(52) U.S. Cl. CPC G06F 9/485; G06F 11/3495

(57) ABSTRACT

Methods, systems, and apparatus, including computer programs encoded on a computer storage medium, for validating and publishing workflows from remote environments. In some implementations, a workflow that specifies a set of computer operations to be performed is received over the communication network. The workflow is tested by performing one or more of the computer operations of the workflow and recording results of performing the one or more computer operations, and/or performing an analysis of the computer operations of the workflow. It is determined that the workflow satisfies at least one predetermined criterion for publishing workflows for use by other computer systems. In response to determining that the workflow satisfies the at least one predetermined criterion for publishing workflows, the workflow is stored in a repository and published to make the workflow available to one or more other computer systems.

### CROSS-REFERENCE TO RELATED APPLICATION

This application claims the benefit of U.S. Provisional Application No. 62/896,217, filed Sep. 5, 2019, and titled “VALIDATING AND PUBLISHING COMPUTING WORKFLOWS FROM REMOTE ENVIRONMENTS,” which is incorporated by reference.

### TECHNICAL FIELD

This disclosure generally relates to managing computer operations.

### BACKGROUND

Servers and other computers experience a wide variety of conditions. Many computer systems require periodic or ongoing maintenance to ensure proper operation and to deal with errors and limitations.

### SUMMARY

In some implementations, a workflow publishing server receives workflows contributed from other systems, tests and validates the workflows, and publishes the workflows to other systems. The workflows may be created by administrators of third-party servers or by other users. The workflow publishing server may validate each of the received workflows. Upon validating a workflow, the workflow publishing server may publish the workflow, making it available to other servers. Publishing a workflow may include adding the workflow to a listing or catalog of available workflows and making the workflow accessible to one or more other servers, e.g., sending the workflow to another server.

In some implementations, validating the workflows may include performing a series of tests on the workflow. If a workflow fails a particular test, the cause of failure may be identified, the workflow may be modified, and then the modified workflow can be retested. The series of tests may include, for example, a test for workflow functionality, a test for workflow performance, a test for system performance in response to executing the workflow, a test for system instability in response to executing the workflow, and/or a test to ensure that the workflow is not accessing any private or forbidden data of the system or its customers. In validating the workflow, the workflow publishing server may leverage a machine learning network (e.g., a machine learning model such as a neural network) to generate testing parameters.

In some implementations, validating a workflow may include determining an impact that the execution of the workflow has on a particular server environment. The sever environment may be generated for testing one or more workflows. The server environment may be a virtual, cloud-based environment.

In some implementations, publishing a workflow may include recommending workflows to users of other servers. Recommending a workflow for a particular server or a user of a server may include monitoring user actions on the server, comparing those actions and the results of those actions to the actions of the workflow and the results of those workflow actions, determining a similarity score, and recommending the workflow based on the similarity score.

In one general aspect, a method, performed by one or more computers, includes: receiving a workflow contributed by a user, where the workflow specifies a set of computer operations to be performed; testing the workflow; determining, based on the testing, that the workflow satisfies at least one predetermined criterion; and in response to determining that the workflow satisfies the at least one predetermined criterion: storing the workflow in a repository; and publishing the workflow to make the workflow available to one or more other computer systems.

Implementations may include one or more of the following features. For example, in some implementations, testing the workflow includes: carrying out the operations of the workflow to obtain a result; and determining whether the result matches a result indicated by the user providing the workflow.

In some implementations, testing the workflow includes: running the workflow in a test environment; identifying elements accessed by the operations of the workflow; and classifying the interactions with the elements.

In some implementations, the method includes, based on the classifications, modifying the workflow to: remove a portion of the workflow; require a user confirmation when running the workflow; or apply a flag to the workflow.

In some implementations, the method includes modifying the workflow to replace one or more operations causing interactions classified as not being secure with one or more replacement operations that are determined to be secure. In these implementations, determining that the workflow satisfies at least one predetermined criterion includes determining that the modified workflow satisfies the at least one predetermined criterion.

In some implementations, testing the workflow includes testing resource consumption of the workflow or stability of the workflow.

In some implementations, testing the workflow includes testing compatibility of the workflow with a plurality of software versions or system configurations.

In some implementations, testing the workflow includes testing applicability of the workflow to a plurality of different system configurations.

In some implementations, the method includes, based on testing the applicability of the workflow: identifying a reference to a resource in the workflow; and replacing the reference to the resource with data designating a customizable field for which a value can be entered by a recipient of the workflow.

In some implementations, the method includes generating, for the workflow, a set of metadata describing the workflow. In these implementations, storing the workflow includes storing the workflow in association with the generated metadata.

In some implementations, the metadata includes a permission needed to run the workflow, a version of software that is compatible with the workflow, a result of the workflow, a data type or customization needed to use the workflow, or a security classification for the workflow.

In some implementations, testing the workflow includes: automatically generating a plurality of computing environments that each have a different combination of software and/or settings; and testing the workflow by monitoring execution of the operations of the workflow by each of the plurality of computing environments.

In some implementations, the plurality of computing environments are cloud-computing-based virtual machines.

In some implementations, the method further includes: receiving log data indicating user-initiated operations performed for a server environment; comparing the set of user-initiated operations with the set of operations of the workflow; determining, based on the comparison, that the set of user-initiated operations and the set of operations of the workflow have at level of similarity that satisfies a predetermined threshold; and in response to determining that the set of user-initiated operations and the set of operations of the workflow have a level of similarity that satisfies a predetermined threshold, providing a recommendation for the workflow. For example, the recommendation can be provided to the server environment or to a device or electronic address (e.g., for an email account, messaging platform, etc.) associated with an administrator or other person associated with the server environment.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIGS. 1A-1B are diagrams that illustrate an example system for providing workflows to remote environments.

FIG. 2 is a diagram that illustrates example interface displaying a workflow listing.

FIG. 3 is an example process for providing workflows to remote environments.

FIGS. 4A-4C are diagrams that illustrate an example system for validating and publishing workflows from remote environments.

FIG. 5 is a diagram that illustrates example process for recommending a workflow.

FIG. 6 is a flow diagram that illustrates a process for validating and publishing a workflow.

Like reference numbers and designations in the various drawings indicate like elements.

### DETAILED DESCRIPTION

In some implementations, a set of computing workflows can be defined to facilitate the management or operation of computer systems. A workflow publishing server is configured to distribute computing workflows to third-party servers and users of third-party servers. The workflow publishing server may send a listing of available workflows to other computer systems. The workflow publishing server may receive requests for one or more workflows indicated in the listing, and, in response, provide the requested workflows. Administrators can select from among the sets of available workflows to enable custom combinations of functionality at the systems they manage.

The workflows can be configured to allow administrators to modify the received workflows. For example, an administrator may modify workflows to better address particular problems or errors experienced by the a server, to customize how the workflows are to be implemented, to select a data source to be used by a workflow, to select a destination to be used by a workflow, to link multiple workflows so the execute together, etc.

In some implementations, the workflow publishing server workflows a remote server based on an analysis of error logs, error reports, and/or server manager logs received from the remote server. In analyzing the error logs, error reports, and/or server manager logs, the workflow publishing server may leverage one or more machine learning to identify conditions present at the remote server and to select relevant workflows.

A workflow can specify a set of computing operations to be performed, potentially along with logic to adaptively or selectively vary which operations are performed and how the operations are performed depending on conditions at a computer system. A workflow can be specified in a workflow module, which can be a data package that indicates the operations, rules, parameters, and other elements or characteristics of the workflow. The workflow module can a portable and redistributable data package that is arranged to be read and processed so a receiving computer system can implement the process or operations that it specifies. In some implementations, a workflow module can be executable or interpretable (e.g., a data package with executable or interpretable code), but this is not required. Each workflow can be specified a corresponding workflow module that specifies the operations and other elements of the workflow, and allows the workflow to be transmitted from one device or system to another device or system that receives and carries out the operations specified in the workflow module.

For example, a workflow can include instructions for a computer system to perform a sequence of actions or functions. The workflow can specify data to be acquired (e.g., to determine current settings, current performance metrics, etc.) and conditions to be evaluated, which can result in different sets of operations being performed by the computer system. Workflows can have many different uses, such as to install patches, change settings, fix causes of errors, optimize performance, resolve incompatibilities, resolve conflicts (e.g., between configuration settings, software versions, files, etc.) correct dependencies (e.g., by updating references to files or data, or providing files or data that were missing or inadequate), refresh caches, optimize data sets, monitor performance, and more. Frequently, a workflow is designed to cause a specific purpose or result when run. An administrator can select a workflows to be run periodically to automate maintenance, or workflows may be run on-demand.

A workflow can be packaged in a standard, lightweight form that can be interpreted or executed without being compiled. Part of a workflow can be a collection of commands to be performed, similar to a script or batch file. As discussed further below, a workflow can have various types of logic integrated into the workflow that allow the execution of the commands to be varied according to the context of the computer for which it is run. For example, a workflow may include different mutually exclusive branches representing different sets of commands, and the computer that executes the workflow can determine which branch is appropriate when the workflow is run. As another example, the workflow can include parameters (e.g., fields, variables, etc.) that are adaptively set for the particular computer running the workflow. These parameters for execution of the workflow may be edited and customized by an administrator, or may be set by the operation of the workflow based on data collected by the workflow through interaction with elements of the computer system. The commands that a workflow instructs to be performed can be commands to invoke functions of software already installed on a computer system, such as functions of an operating system, applications, tools, and so on that are already installed on the computer system. A workflow may also initiate other types of actions, such as interacting with another system using an application programming interface (API), changing settings of the computer or connected system, and so on. In some implementations, the workflow itself may include executable code to be run.

The workflow can be packaged as a module that is redistributable, and so does not need an installation process to be used. Additionally, the module can be editable so that users can tailor the operation for their respective needs. In some implementations, the workflow may designate fields that are customizable by a user. For example, the workflow can include fields for time periods to take actions, resources (e.g., files, folders, devices, etc.) that operations of the workflow act on, values for settings, and so on. Further, the workflow can be editable to add, remove, and modify operations of the workflow.

A server system may provide a configuration interface (e.g., through an application on a client device, a web page, a web application, etc.) that allows an administrator to configure the operation of the server system. The management interface can be configured to communicate with a remote management server to request and receive workflow modules, or have workflow modules and workflow lists pushed from the management server. Once a workflow is received, the configuration interface can include features to request, review, edit, activate, and deactivate workflow modules. For example, the configuration interface can enable a user to view the properties of a specific workflow module, view the operations the workflow module is configured to perform, edit those operations and/or resources the operations use or act on, and save any changes to the customized workflow module. The configuration interface can enable the user to initiate running the workflow, for example, by manually initiating execution, by setting the workflow to be run at a scheduled time (e.g., once or on a recurring schedule), or by setting the workflow to be run in response to detecting one or more conditions (e.g., to run a workflow when load exceeds a threshold, or when a particular type of error occurs, or for another condition).

Each workflow may include or otherwise be associated with a set of metadata that specifies the applicability of the workflow to different systems. For example, the metadata may indicate a type of result achieved by the workflow, a set or range of version codes for software that the workflow is compatible with, a type of error or condition that the workflow is configured to address, user permissions or security credentials needed to run the workflow, dependencies needed by the workflow, a set of applications used by the workflow, a set of settings changed by the workflow, and so on. This metadata can enable computer systems to determine the applicability of different workflows to particular systems.

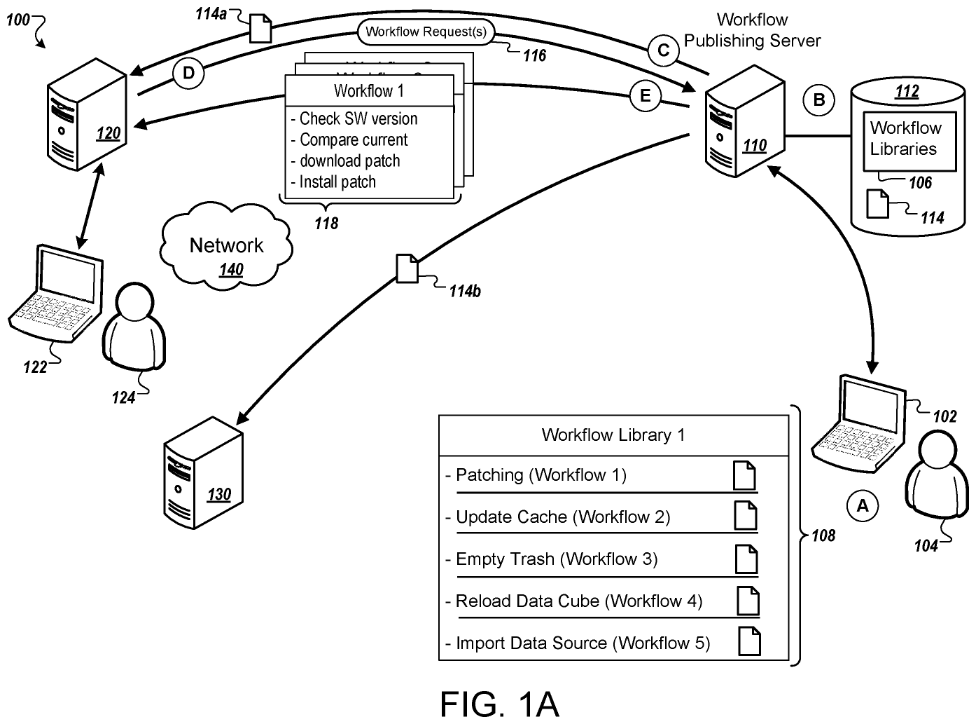

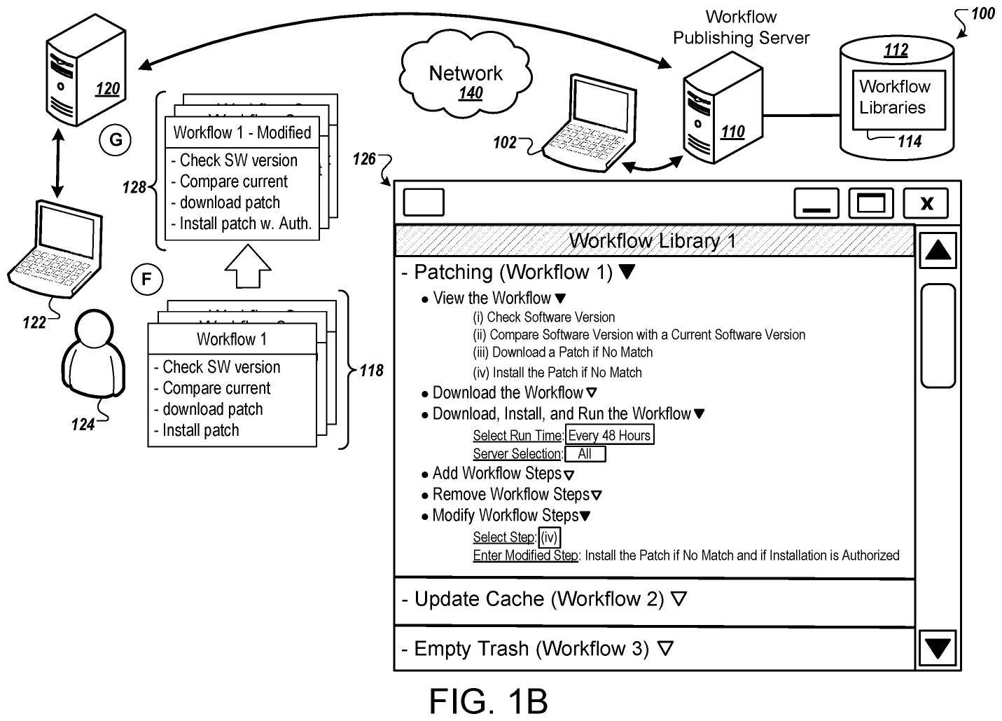

FIGS. 1A-1B are diagrams that illustrate an example system 100 for providing workflows to remote environments, such as third-party servers. The system 100 includes a workflow publishing server 110 and an administrator device 102. The system 100 is able to transmit one or more workflows to servers 120 and 130 over a network 140, so that the servers 120 and 130 can customize and run the received workflows.

The system 100 allows the workflow publishing server 110 to push one or more workflows to the third-party servers 120 and 130. The system 100 also allows one of the third-party servers 120 and 130 to pull one or more workflows from the workflow publishing server 110. The workflow publishing server 110 may provide various different systems with a listing of workflows that are available. When a system receives a workflow from the workflow publishing server 110, the workflow can be customized before it is run. In general, workflows each specify a set of operations to be performed. The workflow can designate the performance of operations to be conditional on the occurrence of particular events or conditions. A workflow may contain mutually exclusive alternatives or branching sets of operations, where one set of operations is performed instead of another set based on the conditions that are satisfied.

FIGS. 1A-1B also illustrate a flow of data, shown as stages (A) to (I), with each representing a step in an example process. Stages (A) to (I) may occur in the illustrated sequence, or in a sequence that is different from the illustrated sequence. For example, some of the stages may occur concurrently.

The administrator device 102 can be a computing device, such as a desktop computer, a laptop computer, a mobile phone, a smart phone, a personal digital assistants (PDA), a tablet computer, or other computing devices. The administrator device 102 can communicate with the workflow publishing server 110 over, for example, the network 140.

The network 140 can include public and/or private networks and can include the Internet.

The workflow publishing server 110 has associated data storage 112 storing one or more workflow libraries 106. The workflow publishing server 110 may include one or more computing devices. The workflow publishing server 110 communicates with servers 120 and 130 over the network 140. In some implementations, one or more computers of the workflow publishing server 110 may communicate with the administrator device 102 and one or more other computers may perform other tasks, such as communicating with the servers 120 and 130. The workflow publishing server 110 may communicate with the servers 120 and 130 through one or more application programming interfaces (APIs).

The servers 120 and 130 may each include one or more computing devices. The servers 120 and 130 are remote with respect to the workflow publishing server 110. The servers 120 and 130 may each be part of a cloud computing platform (e.g., Amazon Web Services (AWS), Microsoft Azure, and so on).

In the example of FIGS. 1A-1B, the workflow publishing server 110 provides workflows for the management of a computing platform that includes software run by the servers 120 and 130. For example, the platform may be a data analytics software platform that includes one or more applications or services, e.g., web server functionality, functionality to access data repositories, query response functionality, functionality to generate visualizations, and so on. The servers 120 and 130 may each run the software of the platform in independently managed systems, for example, for different companies and organizations. As a result, the servers 120 and 130 represent systems that are managed and operated independently from each other and from the workflow publishing system 110. The workflow publishing server 110 can make the workflows available so that the administrators of third-party systems, e.g., servers 120 and 130, can separately select and run the workflows to enhance the maintenance and operation of the software platform. In some implementations, the workflow publishing server 110 is operated by or is affiliated with the provider of the software platform. The workflows may be created, tested, and/or validated before being made available to other systems by the workflow publishing server 110. For example, the workflows can be trusted or certified sets of operations for maintaining or optimizing the software platform.

The techniques disclosed in this document can increase the efficiency and accuracy of server system management. One or more workflows can be accessed, implemented, and processed in order to automate many tasks that would otherwise require significant manual input. In addition, by reducing the amount of manual input needed, server system management using the disclosed techniques is less prone to errors and/or reaction inconsistencies. The disclosed techniques further improve the efficiency and accuracy of server system management by, in some implementations, recommending specific workflows for a particular system based on of their server system and/or their determined needs. The recommended workflows may be determined based on an analysis of one or more error reports or error logs for a system. The recommended workflows may be determined based on analysis of previous actions taken, such as a log of actions that an administrator took to maintain or adjust a server. The recommended workflows may be selected by leveraging one or more machine learning. The disclosed techniques further improve the efficiency and accuracy of server system management by allowing the customization of workflows to the specific needs of a particular administrator or system.

The techniques disclosed in this document can increase the reliability of server systems. Workflow operations may be created and/or customized such that they are performed automatically when certain conditions are satisfied. These operations may include, for example, updating software, installing patches, importing new data, or removing old data that can increase and maintain the reliability of server systems. Conditions which may trigger the performance of these operations may include, for example, a determination that a software update or patch has come available, if a certain amount of time has passed since the operation was last performed, or a determination that new data has come available. Accordingly, server system reliability is improved by ensuring, for example, that the server system is using the latest software, has the latest patches installed, is using the newest available data, etc. In some implementations, the disclosed system is able to recommend one or more workflows to be implemented in a particular server system. The disclosed system may recommend workflows when it determines that the workflow may increase the reliability of the server system or increase the efficiency of the server system, e.g., through an analysis of the server system's error reports or server manager logs.

As shown in FIG. 1A, in stage (A), a workflow library 106 is created or updated. This can involve creating, modifying, testing, and/or validating workflows to be included in the workflow library 106.106 As shown, a first workflow library 106 includes five workflows: a first workflow for patching software (“Workflow 1”), a second workflow for updating a cache of a computer system (“Workflow 2”), a third workflow for emptying a trash folder of a file system (“Workflow 3”), a fourth workflow for reloading an online analytical processing (OLAP) data cube (“Workflow 4”), and a fifth workflow for importing a data source (“Workflow 5”). The administrator 104 may upload the new or modified workflow library 106 to the workflow publishing server 110 over the network 140 or over a different network

Validating or testing a workflow of a workflow library may involve performing one or more of the operations within a workflow (or all operations within a workflow) on a testing environment. The testing environment may be a computer, a computing system, a server environment, a virtual machine, etc. During validation, the operation of the workflow can be tested to ensure proper results are achieved, that security is maintained, compatibility is achieved with an appropriate set of software versions or system configurations, etc.

The workflows in the workflow library 106 can be created on the device 102 or any of various other devices and uploaded to the workflow publishing server 110 for storage and distribution.

In stage (B), the workflow publishing server 110 adds the new or modified workflows to the library 106, which is stored in the data storage 112. This may involve replacing a previous version of the workflow library 106 or updating a previous version of the workflow library 106.

When the workflow publishing server 110 adds the new or modified workflow library 106 to the workflow libraries 106, it may also generate or update a workflow listing 114. The workflow listing 114 may list all workflows included in the workflow libraries 106. The workflow listing 114 may list all workflows from a particular workflow library. For example, there may be separate workflow listings for each workflow library.

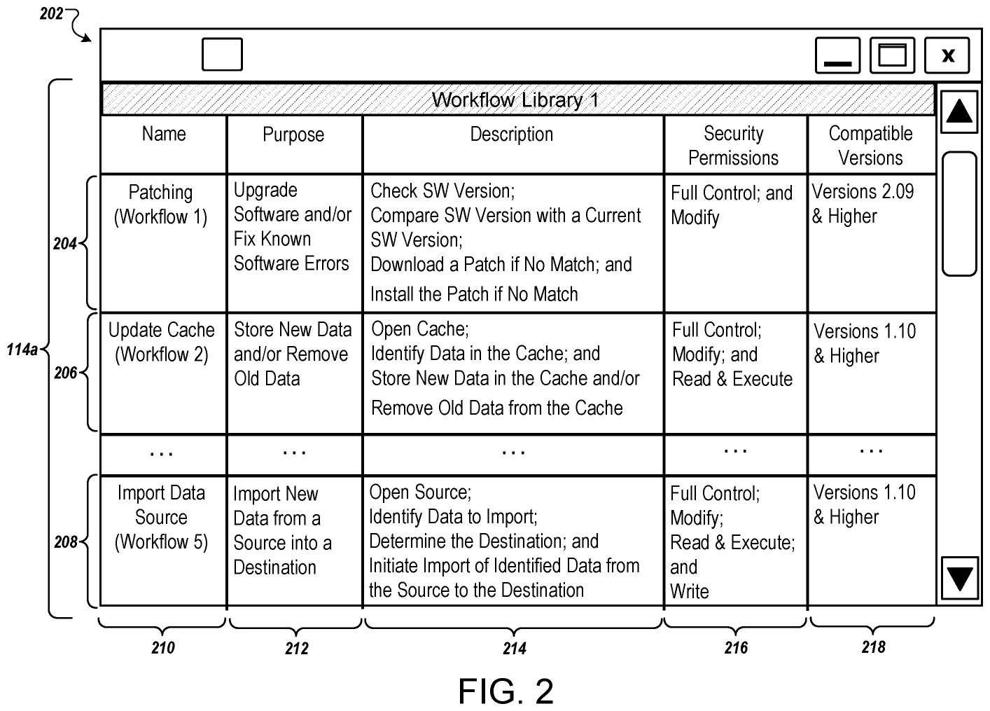

The workflow listing 114 may include information about each of the workflows within the workflow listing 114 as is discussed in more detail below with respect to FIG. 2. This information may include metadata, such as a name of the workflow, a purpose of the workflow or an error that the workflow addresses, a description of the operations within the workflow (e.g., which may also include required conditions for the workflow to be performed), a list of persons who can initiate running of the workflow, security permissions for the workflow, and software versions that the workflow is compatible with.

In stage (C), the workflow publishing server 110 sends workflow listings 114a and 114b to the servers 120 and 130 respectively. The workflow listings 114a and 114b can represent a catalog of the available workflows that can be obtained from the workflow publishing server 110. In some cases, the workflow listings 114a and 114b include all workflows, and in other cases they may represent customized subsets of the total set of workflows, e.g., subsets determined to have appropriate compatibility with or relevance to the servers 120 and 130.

The workflow listings 114a and 114b may be sent by the workflow publishing server 110 to the servers 120 and 130 respectively over the network 140. Here, the workflow publishing server 110 pushes the workflow listings 114a to the server 120, and the workflow listing 114b to the server 130. The workflow publishing server 110 may push the workflow listings 114a and 114b if they have been recently updated (e.g., new workflows have been added, a workflow library which corresponds with the workflow listing has been updated or added, etc.). The workflow publishing server 110 may push these workflow listings 114a and 114b periodically. For example, the workflow publishing server 110 may have scheduled to send the server 120 a workflow listing every two days. The schedule for the server 130 may be different than the schedule of the server 120. For example, the workflow publishing server 110 may have scheduled to send the server 130 a workflow listing every week as opposed to every two days for the server 120.

In some implementations, a server, such as the server 120 or 130, requests a workflow listing from the workflow publishing server 110. The third-party server may schedule workflow listing requests so that they are sent periodically.

In some implementations, different workflow listings 114a and 114b are provided to the servers 120 and 130. For example, the servers 120 and 130 may run different versions of software or have different configurations, so that different sets of workflows are applicable to each. The workflow publishing server 112 can select a customized subset of the workflows in the workflow library 106 for each server, based on known characteristics of the servers. For example, the servers 120 and 130 can periodically provide configuration data indicating software installed, versions of the software, configuration settings, load levels, usage logs, error logs, and so on. From this information, the workflow publishing server can filter the workflow listing 114 so that each workflow listing 114a, 114b has a customized, filtered subset of the workflows.

In some implementations, the workflow listings 114a and 114b are listings of recommended workflows that the workflow publishing server 110 selects as being recommended for the servers 120 and 130. In these implementations, the workflow publishing server 110 may receive (e.g., periodically) error reports or error logs experienced by the server 120 and/or the server 130, and server manager logs from the server 120 and/or 130. The workflow publishing server 110 may analyze these error reports, error logs, and/or server manager logs, and recommend one or more workflows to the respective third-party server.

An analysis of these error reports, error logs, and/or server manager logs may be used to identify workflows that solve specific problems experienced by the respective third-party server and/or workflows that solve similar problems experienced by the respective third-party server. For example, an analysis of an error report of the server 120 may reveal that a number of errors are occurring because the software is out of date. In this example, the workflow publishing server 110 may search through the metadata of the workflows in the workflow libraries 106 to identify any workflows that are related to updating server software or patching server software, and provide the identified workflows to the server 120. A recommended workflow does not need to solve the exact same problem to be recommended because, as will be discussed in more detail below with respect to FIG. 1B, the workflow can be customized for the particular server that it is to be implemented in.

An analysis of these error reports, error logs, and/or server manager logs may reveal workflows that can increase system stability (e.g., if it is determined that one or more errors are due to a high server load, or a high degree of fluctuation in server load, etc.). An analysis of these error reports, error logs, and/or server manager logs may reveal workflows that can reduce user input (e.g., if it is determined that server managers or users are repeatedly doing tasks that could be automated by a workflow, if it is determined that the one or more errors are due to human input error, or if it is determined that the one or more errors are due to inconsistent human oversight). The workflow publishing server 110 may filter out workflows from the recommended workflows if they are incompatible with the respective third-party server, e.g., the workflow requires a different software version than what is installed on the server. The workflow publishing server 110 may provide these recommended workflows to the respective third-party servers as part or all of the workflow listings 114a and 114b.

In some implementations, the administrator 104 may select the one or more workflows to recommend to the servers 120 and 130 based on the results of analysis performed by the workflow publishing server 110 on the respective error reports, error logs, critical log files (e.g., logs for an application server, logs for an intelligence server, logs for queue producers, logs for queue consumers, etc.), core files, crash dumps, and/or server manager logs.

In some implementations, the workflow publishing server 110 leverages one or more machine learning in order to analyze the respective error reports, error logs, critical log files (e.g., logs for an application server, logs for an intelligence server, logs for queue producers, logs for queue consumers, etc.), core files, crash dumps, and/or server manager logs associated with, for example, the servers 120 and 130. In these implementations, the workflow publishing server 110 may capture other attributes and/or characteristics of the servers 120 and 130 such as, for example, the operating system (OS) used, the version of the OS used, applications or services run, versions of applications or services run, hardware characteristics, etc. These attributes and/or characteristics may be made available to and used by the one or more machine learning. In these implementations, the workflow publishing server 110 may feed the error reports, error logs, critical log files, core files, crash dumps, server manager logs monitor, attributes, and/or characteristics associated with, for example, the servers 120 and 130 to the one or more machine learning to see if the server conditions matched known defects. Using this information, the one or more machine learning may determine one or more server conditions. The one or more machine learning may represent the one or more server conditions as a pattern.

The output of the one or more machine learning may be used by the workflow publishing server 110 or the administrator 104 to select one or more workflows for recommendation. For example, if the observed server conditions/pattern matched a previously known defect, the one or more machine learning may recommend a known workflow associated with those conditions. If the observed server conditions/pattern did not match a known defect, then an analysis would be done for these new conditions/new pattern, and a new workflow may be generated to address these new conditions/new pattern. The analysis may be performed by a user of the workflow publishing server 110. The new workflow may be generated by a user of the workflow publishing server 110. The analysis may be performed automatically by the workflow publishing server 110 through, for example, trial and error and/or leveraging one or more machine learning to determine which workflows are likely work based on, for example, what workflows are associated with conditions similar to the observed conditions, what workflows have a high rate of success, etc. For example, the workflow publishing server 110 may attempt to use existing workflows to see if any have a beneficial effect on the server conditions. The workflow publishing server 110 may test the existing workflows in the order of which are determined to have the highest likelihood of success based on, for example, leveraging the one or more machine learning. If one or more workflows are determined to have a beneficial effect on the observed server conditions (e.g., less defects, less severe defects, better performance, etc.), the workflow publishing server 110 may associate those one or more workflows with the observed conditions/pattern, e.g. associate those one or more workflows with the specific defect detected.

The one or more machine learning may include one or more machine learning models. The one or more machine learning models may include an unsupervised learning model.

The workflow listing 114a may be the same or different from the workflow listing 114. The workflow listing 114 may be modified for the server 120 in order to generate the workflow listing 114a. For example, the workflow listing 114a may contain the workflows found in the workflow listing 114 that are compatible with the software of server 120. Similarly, the workflow listing 114b may be the same or different from the workflow listing 114. The workflow listing 114 may be modified for the server 130 in order to generate the workflow listing 114b. For example, the workflow listing 114b may contain the workflows found in the workflow listing 114 that are compatible with the software of server 130.

In stage (D), after having received the workflow listing 114a, a user 124 of the client device 122 may select one or more workflows from the workflow listing 114a for download from the workflow publishing server 110. In selecting one or more workflows from the workflow listing 114a, one or more workflow requests 116 are generated by the server 120 and sent to the workflow publishing server 110. The one or more workflow requests 116 may contain a name or other indication of the one or more selected workflows, and/or a name or other indication of the source of the one or more workflows, such as a name or other indication of the one or more workflow libraries that correspond with the one or more selected workflows.

The one or more workflow requests 116 may contain additional information, such as information about the server 120. This additional information may contain, for example, the software version(s) used by the third-party server, error logs or reports related to the third-party server, server manager logs, storage capacity of the third-party server, remaining storage space of the third-party server, performance information related to all or part of the third-party server (e.g., bandwidth, load experienced, amount of memory, number of processors, type of processors, etc.), The one or more workflow requests 116 may be sent to the workflow publishing server 110 over the network 140.

In some implementations, the one or more workflow requests 116 do not specifically name or identify one or more workflows. In these implementations, the workflow requests 116 may contain a query for workflows for the workflow publishing server 110. The query may include information naming or describing a specific error, condition, or other issue experienced by the server 120. The workflow publishing server 110 may access the workflow libraries 106 through the data storage 112, and compare the query information to the metadata for each of the workflows. In comparing the query information to the workflow metadata, the workflow publishing server 110 may identify one or more workflows that specifically address the error, condition, or other issue experienced by the server 120, and/or one or more workflows that are related to the error, condition, or other issue experienced by the server 120. The workflow publishing server 110 may leverage one or more machine learning in identifying the one or more workflows.

In stage (E), in response to receiving the one or more workflow requests 116, the workflow publishing server 110 sends the requested workflows 118 (or a subset of the requested workflows) to the server 120. The workflow publishing server 110 may first analyze the received one or more workflow requests 116 to determine which workflows are being requested. The workflow publishing server 110 may access the data storage 112 to obtain the requested workflows 118 in preparation of sending the requested workflows 118 to the server 120. Here, the user 124 had requested three workflows: including Workflow 1, Workflow 2, and Workflow 3. These three workflows make up the requested workflows 118 and are sent to the server 120. In addition to sending the workflows, the workflow publishing server 110 may provide instructions for installing and running each of the workflows in the requested workflows 118.

In some implementations, the workflow publishing server 110 removes one or more workflows from the requested workflows 118 due to a determination that one or more workflows are incompatible with the server 120. This subset of the requested workflows 118 may be sent to the server 120 in place of the requested workflows 118. In these implementations, a notification may be provided to the server 120 indicating that one or more workflows were not sent due to incompatibility.

In some implementations, the workflow publishing server 110 pushes one or more workflows to the server 120 or the server 130 without the need for any workflow requests, such as the one or more workflow requests 116. In these implementations, the workflow publishing server 110 may push recommended workflows in response to analysis of a third-party server's error reports, error logs, and/or server manager logs. The workflow publishing server 110 or the administrator 104 may identify which workflows to recommend in accordance with the methods described above with respect to stage (C).

In the example, a workflow module 118a is shown as an example of a data package that defines a particular workflow, e.g., Workflow 1 for patching. For convenience and simplicity in illustration, the module 118a is shown with merely a text summary of the involved actions rather than the actual code, instructions, rules, etc. that would be provided in the module 118a for a computer to carry out the workflow. The workflow module 118a may be a data package or one or more files (e.g., script files) that provides machine-readable instructions for a set of operations to be performed. For example, the workflow module 118a may include instructions for the client device 122 (and/or the server 120) to perform a set of operations related to patching. Specifically, the workflow module 118a may include, for example, instructions to (i) check the software version (e.g., current software version and/or required software version), (ii) compare the current software version with the required software version, (iii) download a patch for the required software version, and (iv) install the patch for the required software version. The workflow module 118a can be arranged and formatted so that the client device 112 or another device receiving the workflow module 118a can automatically perform some or all of the operations of the specified workflow upon receiving and processing the workflow module 118a.

The workflow module 118a may optionally be executable. That is, the workflow module 118 may include an executable file (e.g., compiled software code) that can be executed by the client device 122 (and/or the server 120). Alternatively, the workflow module 118a may be a data package containing multiple executable files that can be executed by the client device 122 (and/or the server 120). This is only one of many options for specifying a workflow, many of which do not involve or require executable code. In fact, for cross-platform support, it may be advantageous in many implementations to specify instructions in a form that is not compiled for a specific operating system or architecture, but nevertheless indicates operations to perform.

Similarly, the workflow module 118a may be interpretable. That is, the workflow module 118a may include instructions that are not compiled but nevertheless can be performed by the client device 122 (and/or the server 120) after receiving the workflow module 118a.

As shown in FIG. 1B, in stage (F), the user 124, through an interface 126 of the client device 122, inspects the requested workflows 118 and generates a set of modified workflows 128 from the requested workflows 118. Here, the user 124 has selected Workflow 1 in the interface 126, allowing the user 124 to inspect Workflow 1 and modify it. The user 124 has selected the option to “View the Workflow,” revealing the operations contained within Workflow 1. These operations include a first operation to check the software version of the server, a second operation to compare the software version with a current software version, a third operation to download a software patch if the checked software version does not match the current software patch, and a fourth operation to install the software patch if the checked software version does not match the current software patch. Other options that the user 124 has not selected include an option to download the workflow, an option to add workflow steps (e.g., add additional operations to Workflow 1 that may or may not be conditional, or add alternative operations to the workflow), and an option to remove workflow steps (e.g., remove an operation from Workflow 1).

An option that the user 124 has selected is an option to download, install, and run the workflow. By selecting this option, the user 124 is presented a field to select or enter a run time, and a field to select or enter the specific servers or server environments that Workflow 1 should be installed on or otherwise implemented in. In the run time field, the user 124 has selected to run Workflow 1 every 48 hours. The user 124 may have been able to select or enter other options, such as every 12 hours, every 24 hours, every week, every month, every year, once—immediately, once—with a delay (e.g., a delay of 1 hour, 2 hours, 12 hours, 1 day, 1 week, etc.), etc. In the server or server environment field, the user 124 has selected or entered “all.” Accordingly, the user 124 has chosen for Workflow 1 to be installed and run on all of server 120's servers and/or server environments, or on all of server 120's compatible servers and/or server environments.

An option the user 124 has selected is an option to modify workflow steps. By selecting this option, the user 124 is presented a field to select or enter a step, e.g., an operation, to modify and a field to enter the modification(s). Here, the user 124 has selected or entered the fourth operation, the operation to install the software patch if the checked software version does not match the current software patch. The user 124 has modified the fourth operation so that it now includes an additional condition that the installation of the patch must also be authorized by a server manager or admin.

The user 124 may be able to modify the workflows in other ways. For example, the user 124 may be able to select from a list of recommended or frequently used operations. This list may be presented to the user 124 on the interface 126. When the user selects an operation from the list, the operation may replace a currently selected operation or may be added to the operations of the corresponding workflow. The user 124 may be able to drag one or more operations from the list into the workflow. The user 124 may be able to rearrange operations in the workflow by, for example, dragging them into different positions. The user 124 may be able to modify a workflow by entering code that is then added to the computer code corresponding with the workflow, e.g., in order to add one or more new operations to the workflow, add one or more conditions to the workflow or to individual operations in the workflow, etc. The user 124 may be able to modify a workflow by modifying the computer code corresponding with the workflow, e.g., in order to modify existing operations or conditions, remove existing operations or conditions, etc.

The operations of the workflow may be conditional on one or more events being satisfied. These conditions may be temporal conditions, e.g., a date, an elapse of a certain amount of time, etc. These conditions may be satisfied through a triggering event, e.g., the occurrence of an error or a particular error, an instruction or action by a server manager or administrator, a state of the server system, a server load threshold being met, etc. These conditions may be satisfied through the successful performance of one or more higher order operations in the set of operations, e.g., operations that are to be performed before the operation at issue. These conditions may be predetermined. These conditions may be set by the user 124 through the interface 126.

Similarly, the workflow itself may be conditional on one more events being satisfied before it is processed. These conditions may be temporal conditions, e.g., a date, an elapse of a certain amount of time, etc. These conditions may be satisfied through a triggering event, e.g., the occurrence of an error or a particular error, an instruction or action by a server manager or administrator, a state of the server, a server load threshold being met, etc. These conditions may be satisfied through the successful performance of an operation of another workflow or of the successful processing of another workflow. These conditions may be predetermined. These conditions may be set by the user 124 through the interface 126. These conditions may include the occurrence of an event, the nonoccurrence of an event, particular data being identified, particular data not being identified, particular data being matched, particular data not being matched, the time of day, the day of the week, the time of year, a status of a server, the load on a server reaching a threshold level, the security permissions of a user, etc.

The workflows may each contain branching or alternative operations. For example, Workflow 1 may contain a set of alternative operations where a match is found between the checked software version and the current software version. In this example, Workflow 1's alternative operations may include an operation to schedule a check for updates one week from now, an operation to generate a notification indicating that the server is currently running the most up-to-date software, and an operation to generate a notification indicating the scheduled software check if the software check is successfully scheduled. As demonstrated in the example, the branch or path of operations that is performed during the processing of a workflow, such as during the processing of Workflow 1, may depend on the particular conditions satisfied and/or on the successful performance of a higher order operation.

By modifying (e.g., customizing) the requested workflows 118 for the server 120, or for particular servers or server environments within or part of the server 120, the user 124 generates the set of modified workflows 128. In some implementations, the modified workflows 128 are generated in response to the user saving or submitting their modifications to the requested workflows 118.

The user 124 may be able to modify the requested workflows 118 in other ways. For example, the user 124 may be able to select a source to be used by a particular workflow, such as a data source. For example, the user 124 may be able to select a destination to be used by a particular workflow. For example, the user 124 may be able to string multiple workflows together. For example the user 124 may be able to select a script to be used by or with a particular workflow.

At stage (G), the user 124 implements the modified workflows 128 into the server 120. Implementing the modified workflows 128 in the server 120 may involve installing the modified workflows on the server 120, on one or more particular servers part of the server 120, or one or more particular server environments within or part of the server 120. Implementing the modified workflows 128 in the server 120 may involve running (e.g., processing) the modified workflows 128, scheduling one or more times to run each of the modified workflows 128, or setting one or more other conditions (e.g., triggering events) for each of the modified workflows 128 that when satisfied result in running the modified workflows 128. Implementing the modified workflows 128 in the server 120 may involve stringing a workflow from the modified workflows 128 to another workflow, such that the processing of one of the strung workflows is a precondition to the processing of the other strung workflow.

FIG. 2 is a diagram that illustrates example interface 202 displaying the workflow listing 114a as previously shown in FIG. 1 a in more detail. As previously mentioned, the workflow listing 114a may contain metadata for each of the workflows within the listing. The metadata may include a name of the workflow, a purpose of the workflow or an error that the workflow addresses, a description of the operations within the workflow (e.g., which may also include required conditions for operation performance), a list of persons who can access the workflow, security permissions for the workflow, and software versions that the workflow is compatible with.

As shown, the workflow listing 114a includes a first row 204 for Workflow 1, a second row 206 for Workflow 2, and a final row 208 for Workflow 5. The workflow listing 114a also includes a column 210 for the names of each of the workflows, a column 212 for the purpose or error to be addressed by each of the workflows, a column 214 for the descriptions and/or required conditions of each of the workflows, a column 216 for the security permissions required for each of the workflows, and a column 218 for the compatible software versions for each of the workflows.

As shown, different workflows may require different security permissions. For example, as shown in column 216 of row 204, Workflow 1 requires a higher security permission of “Full Control” or “Modify” in order to install and/or process Workflow 1, whereas, as shown in column 216 or row 208, Workflow 5 allows many more security permissions to install and/or process Workflow 5. The reason why Workflow 1 may require higher security permissions than Workflow 5 may be due to the operations within each of the workflows. The operations of Workflow 1, as can be seen in column 214 of row 204, involve downloading and installing software which may be viewed as high risk operations (or high risk when compared with the operations of Workflow 5). The operations of Workflow 5, as can be seen in column 214 of row 208, involve identifying and importing data, which may be viewed as low or medium risk operations (or low or medium risk when compared with the operations of Workflow 1).

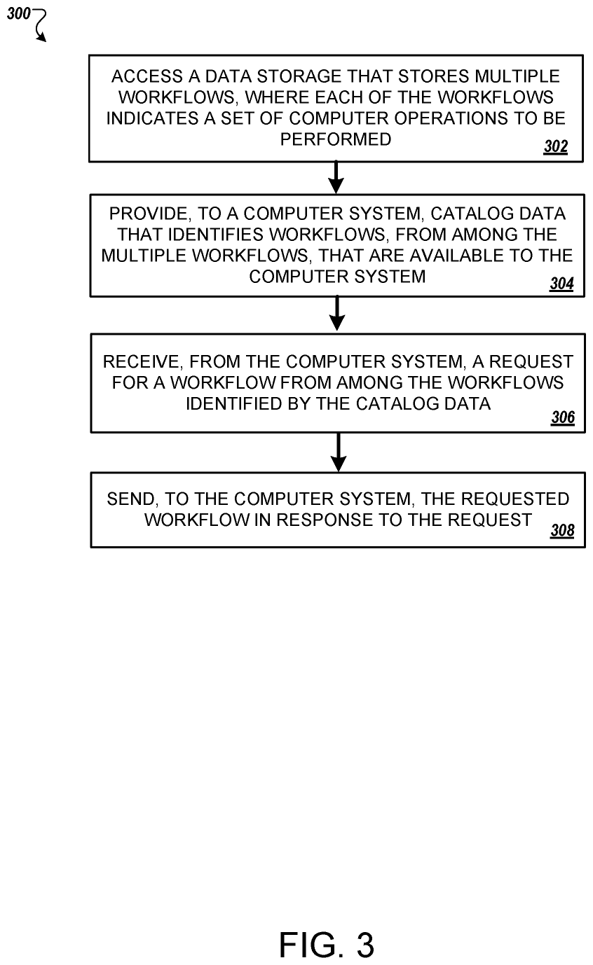

FIG. 3 is an example process 300 for transmitting workflows to remote environments. The process 300 can be performed, at least in part, using the system 100 described herein.

The process 300 includes accessing data storage storing multiple workflows, where each of the workflows indicates a set of computer operations to be performed (302). The computer operations may include downloading software, checking for software updates, updating software, installing software, running software, importing data, exporting data, checking for new or different data, running a script, generating data, generating a notification, sending a notification, etc. The computer operations may be conditional on the satisfaction of one or more requirements. These requirements may include the performance of another operation, the processing of a workflow, a time having elapsed, a triggering event, etc. The data storage may be on-site.

The data storage can store metadata associated with the workflows. The metadata for a particular workflow may include information such as a name of the workflow, a purpose of the workflow or an error that the workflow addresses, a description of the operations within the workflow, a list of persons who can access the workflow, security permissions for the workflow, and/or software versions that the workflow is compatible with.

A workflow can indicate a sequence of multiple operations that are to be performed in a predetermined order. Examples of operations include checking a software version of a server, checking the most recent software version, comparing software versions, downloading software, uploading software, identifying data, uploading data, storing data, downloading data, deleting or clearing data, comparing data, determining destinations, and/or determining sources. As an example, a workflow may include an operation to check the version of software currently used by a particular server, to check the most recent version of the software, and to compare the currently used version with the most recent version. In this example, the operations may need to be performed in a predetermined order. For example, the workflow may need to first check the version of software currently used by the server, then check the most recent version of the software once the first check is performed, and, only after both checks are performed, compare the currently used version with the most recent version. The predetermined order may be set when the one or more workflows are initially created, e.g., by the administrator 104. The predetermined order may modified at a third party server, e.g., by the user 124 of the client device 122 or by a different user of a different client device. The predetermined order may be set at a third party server, e.g., by the user 124 of the client device 122 or by a different user of a different client device.

A workflow may include multiple conditional operations that are designated to be performed when corresponding conditions are satisfied. Examples of conditions include the occurrence of an event, the nonoccurrence of an event, particular data being identified, particular data not being identified, particular data being matched, particular data not being matched, the time of day, the day of the week, the time of year, a status of a server, the load on a server, the security permissions of a user, etc.

In some cases, a workflow includes a chain of conditional operations. The chain of conditional operations may include a first operation and a first condition and a second operation and a second condition. Performance of the first operation may be dependent on the first condition being satisfied, and performance of the second operation may be dependent on the second condition and the first condition being satisfied. As an example, when either the first condition or the second condition is not satisfied, the server running the workflow may automatically abort the workflow and/or may automatically restart the workflow, e.g. after a predetermined amount of time. Similarly, when both the first condition and the second condition are not satisfied, the server running the workflow may automatically abort the workflow and/or may automatically restart the workflow, e.g. after a predetermined amount of time. As an example, when the first condition is satisfied but the second condition is not satisfied, the server running the workflow may wait a predetermined amount of time before automatically aborting the workflow or automatically restarting the workflow. During this predetermined amount of time, the server and/or the workflow may check to see if the second condition is satisfied.

A workflow may contain an operation to check a software version used by the server, compare the employed software version with the most recent version of the software, download the most recent software version if the employed version does not match the most recent version, and install the most recent software version if the employed version does not match the most recent version and if the most recent version downloaded successfully. In this example, the first condition may be whether the employed version of the software matches the most recent version of the software. In this example, the second condition may be whether the most recent software version downloaded successfully. A chain of conditional operations may also include additional operations and conditions.

In some cases, one or more workflows specify multiple alternative sequences of operations to be performed based on conditions present when the one or more workflows are processed. The multiple alternative sequences may be mutually exclusive. The computer or server that executes the workflow can determine which sequence of operations is appropriate when the workflow is run. The conditions for determining a sequence of operations to follow may be the same as the conditions for conditional operations. For example, these conditions may include the occurrence of an event, the nonoccurrence of an event, particular data being identified, particular data not being identified, particular data being matched, particular data not being matched, the time of day, the day of the week, the time of year, a status of a server, the load on a server reaching a threshold level, the security permissions of a user, etc. As an example, a workflow may have two alternative sequences of operations, a first sequence to be performed on weekdays and a second sequence to be performed on weekends. When the computer or server runs the workflow, the computer or server may make a determination as to whether it is a weekday or a weekend. If the computer or server determines that it is a weekday, the computer or server will provide for the first sequence of operations in the workflow to be run. Alternatively, if the computer or server determines that it is a weekend, the computer or server will provide for the second sequence of operations in the workflow to be run.

In some cases, one or more workflows specify operations that involve executing one or more scripts or executables. As an example, executables may include programs and certain files, e.g., files that are .BAT, .COM, .EXE, .BIN, .DMG, and/or .APP files. As an example, a script may include a series of commands within a file that is capable of being executed without being compiled. The scripts may include Python scripts, PHP scripts, JavaScript scripts, etc.

In some cases, one or more workflows specify operations that include shutting down or restarting a server environment. The operations may include a restart operation. The operations may include a shutdown operation. As an example, the operations for shutting down or restarting a server environment may be for shutting down or restarting one or more particular computers of the server environment.

In some cases, one or more workflows specify operations that involve accessing data from a data repository or data indicating operational characteristics of a data repository. As an example, a data repository may include a server, e.g. an on-premises server or a third-party server, or part of a server. As an example, a data repository may include a database. As an example, a data repository may include cloud storage that is provided by a cloud-computing platform. As an example, operational characteristics of the data repository may include log data for accesses to the data repository, a status of the data repository (e.g., an indication of whether or not it is experiencing an error or has recently experienced an error), a number of requests for data within the data repository, performance characteristics (e.g., an average time to process requests for data within with data repository, a maximum time, etc.), an indication of the specific data requested from the data repository, an indication of data added to the data repository, one or more dates and times associated with a request for data, one or more dates and times associated with data added to the data repository, etc.

In some cases, one or more workflows represent a template of operations to be customized for a particular server environment. For example, a workflow may include one or more fields that can be filed, customized, or modified. In this example, the one or more fields may be empty and may need to be filled in, e.g., by the user 124 using the user device 122. In this example, the one or more fields may have default values that are automatically set, e.g., by the workflow publishing server 110, or by are set by a user, e.g., the administrator 104 through the administrator device 102. As another example, one or more fields may be added to the workflow to, for example, add additional operations, further define operations, add conditions to operations, etc. The fields may correspond with an operation, with a condition for a conditional operation, with a condition for a particular sequence of operations, with multiple operations, etc. The fields may allow a user to, for example, specify a run time for the workflow, specify one or more server environment on which to run the workflow, add one or more operations, modify one or more existing operations, remove one or more existing operations, rearrange an order of the operations, set an order of the operations, set a hierarchy of the operations, divide the operations into multiple sequences of operations, assign one or more operations to a specific sequence of operations, remove one or more operations from a sequence of operations, etc.

In some cases, one or more workflows address specific errors or conditions of server environments, and have metadata indicating the errors or conditions they address. As an example, the specific errors or conditions may include the cache allocated to a server environment being full or approaching capacity (e.g., 70% full, 80% full, 90% full, etc.), poor performance of the server environment (e.g., unacceptable load times, render times, reporting times, etc.), a server environment crash, the amount of load on the server environment, hardware failure, etc. As an example, the metadata indicating the errors or conditions may include a purpose of the one or more workflows, an error that the one or more workflows address, a description of the operations within the one or more workflows. In addition, metadata such as security permissions may also provide some indication of the errors or conditions that the one or more workflows address.

The process 300 includes providing, to a computer system, catalog data identifying workflows, from among the multiple workflows, that are available to the computer system (304). The catalog data may include or be a workflow listing, e.g. workflow listings 114a or 114b as shown in FIG. 1. The catalog data may identify a set of workflows. The catalog data may contain one or more workflow libraries, e.g. workflow library 106 as shown in FIG. 1). The catalog data may be a workflow library. The catalog data may contain metadata that corresponds to one or more workflows. The metadata may include a name of the one or more workflows, a purpose of the one or more workflows or an error that the one or more workflows address, a description of the operations within the one or more workflows (e.g., which may also include required conditions for operation performance), a list of persons who can access the one or more workflows, security permissions for the one or more workflows, and software versions that the one or more workflows are compatible with. In some implementations, the identified workflows are those workflows that are compatible with the computer system. The computer system may be a server, a group of servers, a server system, or a server environment (e.g., the server 120 as shown in FIGS. 1A-1B). The computer system may be part of a cloud-computing service or environment.

In some cases, providing the catalog data includes publishing the catalog data to multiple systems. As an example, the multiple systems may include one or more server systems, server environments, computer systems, etc. For example, the multiple systems may include the server 120 and the server 130 shown in FIG. 1. As an example, the catalog data may be published over a public or private network such as the Internet.

In some cases, providing the catalog data includes pushing the catalog data to one or more systems. For example, the catalog data may be pushed by the workflow publishing server 110 shown in FIG. 1. As an example, the one or more systems may include one or more server systems, server environments, computer systems, etc. In this example, the one or more computer systems may include or be part of one or more server systems or server environments. For example, the one or more systems may include the server 120 and/or the server 130 shown in FIG. 1.

In some cases, the catalog data includes metadata associated with each of the workflows. The metadata may indicate software the associated workflow applies to, conditions the associated workflow applies to, permissions needed for the associated workflow, a description for the associated workflow, and/or an error addressed by the associated workflow. As an example, conditions that a workflow applies to or errors addressed by the workflow may include conditions or errors experienced by a server system or environment running the workflow. In this example, the conditions may include the cache allocated to a server environment being full or approaching capacity (e.g., 70% full, 80% full, 90% full, etc.), poor performance of the server system or environment (e.g., unacceptable load times, render times, reporting times, etc.), a server system or environment crash, the amount of load on the server system or environment, hardware failure, etc. As an example, the permissions needed for the associated workflow may include security permissions. In this example, security permissions may include a full control permission, a modify permission, a read and execute permission, a write permission, etc. As an example, a user of the server system or server environment may be assigned one or more permissions, e.g. by an administrator of the server system or server environment.

The metadata of the workflows may be used by the computer system in performing actions or in preventing actions from being performed. For example, the metadata associated with a workflow may be used by the computer system to prevent some users from running the workflow on the computer system if they do not have the requisite permission level as indicated by the metadata. As another example, the metadata indicating a software associated with a workflow may be used by the computer system to prevent the workflow from being run if the workflow is no longer compatible with the computer system, e.g. where the software on the computer system has been updated or upgraded since the workflow was downloaded from the workflow publishing server 110 shown in FIG. 1. Similarly, a user of the computer system may use the metadata indicating the software to ensure that the workflow is compatible. A user of the computer system may adjust or modify the metadata of a workflow. For example, a user may change the conditions, permissions, description, and/or error addressed of a particular workflow.

The process 300 includes receiving, from the computer system, a request for a workflow from among the workflows identified by the catalog data (306). The request may specifically name or otherwise identify one or more workflows from the workflows identified by the catalog data. In some implementations, the request does not specifically name or specifically identify one or more workflows. In these implementations, the request may contain a query. The query may include information naming or describing a specific error, condition, or other issue experienced by the computer system. The query information may be compared to metadata corresponding to the multiple workflows. In comparing the query information to the workflow metadata, the system (e.g., the system 100 as shown in FIGS. 1A-1B) or a part of the system (e.g., the workflow publishing server 110 as shown in FIGS. 1A-1B) may identify one or more workflows of the multiple workflows that specifically address the error, condition, or other issue experienced by the computer system, and/or one or more workflows that are related to the error, condition, or other issue experienced by the computer system. The system (e.g., the system 100 as shown in FIGS. 1A-1B) or a part of the system (e.g., the workflow publishing server 110 as shown in FIGS. 1A-1B) may leverage one or more machine learning in identifying the one or more workflows of the multiple workflows.

The process 300 includes sending, to the computer system, the requested workflow in response to the request (step 308). The requested workflow may be sent to the computer system over a network. The system (e.g., the system 100 as shown in FIGS. 1A-1B) or a part of the system (e.g., the workflow publishing server 110 as shown in FIGS. 1A-1B) may check to confirm that the workflow requested is compatible with the computer system before sending.

The process 300 optionally includes receiving a request for catalog data. In these cases, providing the catalog data includes providing the catalog data in response to receiving the request for catalog data. For example, the catalog data may be provided by the workflow publishing server 110 shown in FIG. 1 to the server 120 in response to a request for the catalog data being sent by the server 120 to the workflow publishing server 110. The request for the catalog data and the catalog data may be sent over a public or private network such as the internet.

The process 300 optionally includes identifying a configuration of the computer system, and providing a customized subset of the workflows based on the configuration of the computer system. As an example, the configuration of the computer system may include one or more characteristics of the computer system. As an example, the configuration of the computer system may indicate software installed on the computer system, versions of the software installed, configuration settings of the computer system, load levels experienced by the computer system, usage logs of the computer system, error logs of the computer system, and so on. As an example, in providing a customized subset of workflows, the workflow publishing server 110 shown in FIG. 1 can filter the workflows to identify those that are compatible with the configuration of the computer system, or are compatible with one or more characteristics of the configuration of the computer system.

In some cases, providing a customized subset of the identified workflows is based on a software version for software used by the computer system, a setting of the computer system, a usage pattern of the computer system, an error encountered by the computer system, and/or a limitation encountered by the computer system. For example, each workflow that is compatible with a first version of a particular software, e.g. version 2.1, may be placed in the subset, e.g. by the workflow publishing server 110 shown in FIG. 1. In this example, the first version of the software may be the version used by the computer system, e.g. a server, requesting the workflows.

As an example, settings may include configuration settings. In this example, all workflows that are compatible with the configuration settings may be placed in the subset. The configuration settings may correspond with the computer system. The configuration settings may include, for example, a cache size of the computer system, memory allocated to the computer system, processors allocated to the computer system, bandwidth of the computer system, software used by computer system, software versions used by the computer system, etc.

As an example, usage patterns may include operation patterns associated with users of the computer system. The usage patterns may be determined by the workflow publishing server 110 shown in FIG. 1 by, for example, leveraging one or more machine learning. The usage patterns may indicate, for example, operations frequently performed by users of the computer system, operations that are frequently performed together, operations that typically follow an earlier operation, operations are typically performed during a particular state of the computer system (e.g., particular date, particular time of the day, particular load level on the computer system or threshold load level being reached, etc.), etc.

As an example, errors encountered by the computer system may include the cache allocated to computer system being full or approaching capacity (e.g., 70% full, 80% full, 90% full, etc.), poor performance of the computer system (e.g., unacceptable load times, render times, reporting times, etc.), the computer system experiencing a crash, the amount of load on the computer system reaching a threshold level, hardware failure, etc. In determining whether the computer system has encountered an error, as an example, the workflow publishing server 110 may analyze error reports, error logs, and/or server manager logs of the computer system in order to identify errors encountered by the computer system. In analyzing error reports, error logs, and/or server manager logs, the workflow publishing server 110 may, for example, leverage one or more machine learning.

The process 300 optionally includes receiving information, from the computer system, indicating a log of actions performed by the computer system, determining a level of similarity of actions in the log with operations in a workflow of the multiple workflows, determining that the level of similarity satisfies a threshold; and providing, to the computer system, the workflow or a recommendation for the workflow based on determining that the level of similarity satisfies the threshold. As an example, the information may include usage logs or server manager logs. As an example, determining a level of similarity may include determining whether a first operation performed by the computer system is found in a workflow, determining whether one or more operations performed by the computer system before or after performing the first operation are also found in the workflow, determining whether the workflow includes any operations that are not performed by the computer system, determining whether the workflow does not include any operations that are performed by the computer system, determining whether the workflow does not include any operations within a subset of operations performed by the computer system (e.g., those operations surrounding the first operations, a group of operations that are frequently performed together on the computer system, etc.), determining if the conditions for an operation performed by the computer system are the same or similar to the conditions for performing a corresponding operation found in a workflow, etc. In determining a level of similarity, as an example, the workflow publishing server 110 shown in FIG. 1 may leverage one or more machine learning. The threshold may be set by a user. The threshold may be set to, for example, 60%, 70%, 80%, or 90% similarity.

The process 300 optionally includes receiving data, from the computer system, indicating errors or conditions of a server system, identifying one or more workflows of the multiple workflows that are configured to address the errors or conditions, and providing, to the computer system, the workflow or a recommendation for the workflow. As an example, the data may include usage logs, error reports, error logs, and/or server manager logs. In identifying one or more workflows, as an example, the workflow publishing server 110 may leverage one or more machine learning.

The process 300 optionally includes receiving a query from the computer system, determining a workflow of the multiple workflows based on the query, and providing, to the computer system, the workflow or a recommendation for the workflow in response to receiving the query. As an example, a query may be or include a request for a catalog of available workflows, a request for one or more identified workflows, a request for compatible or recommended workflows, etc. The query may include, for example, an indication of one or more specific workflows. The query may include, for example, one or more criteria for workflows that are to be used in identifying one or more workflows to be sent to the computer system in response. The query may include information corresponding with the computer system such as, for example, configuration settings of the computer system. In some cases, the query may be include a request for documents, e.g. from the workflow publishing server 110 shown in FIG. 1. In these cases, the workflow publishing server 110 may identify one or more workflows that correspond with the requested documents, and may send the identified one or more workflows to the computer system or may send a recommendation including an indication of the identified workflows to the computer system.

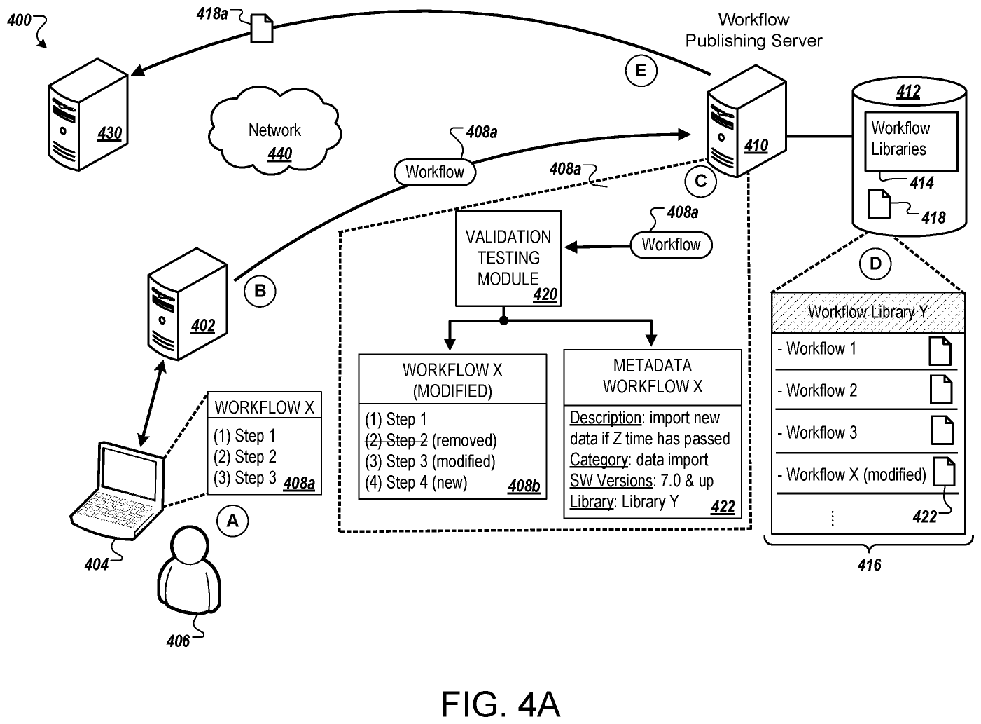

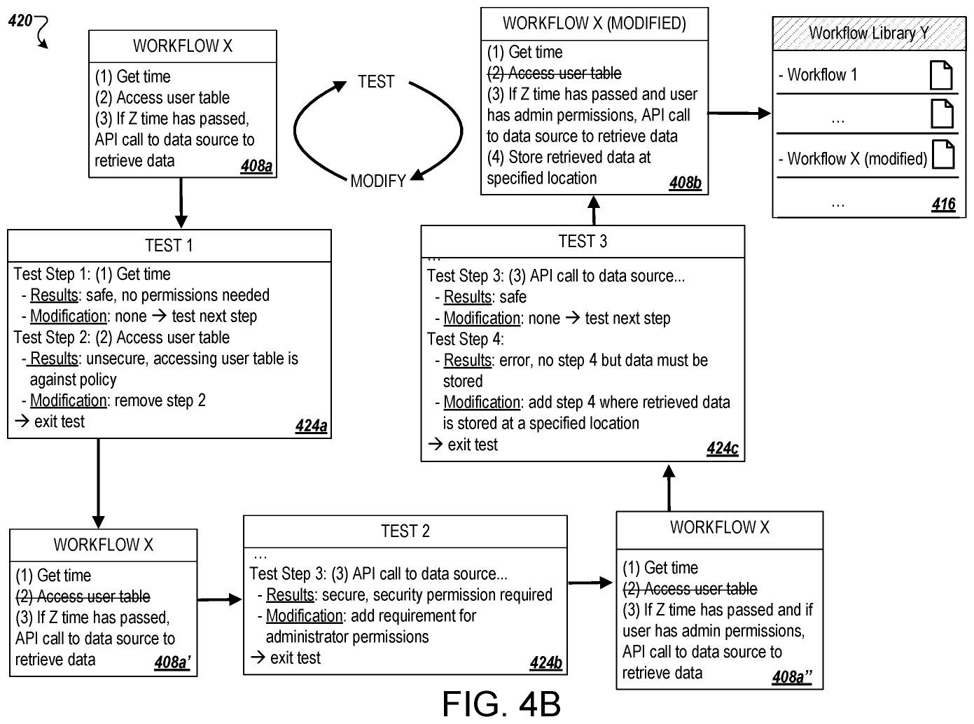

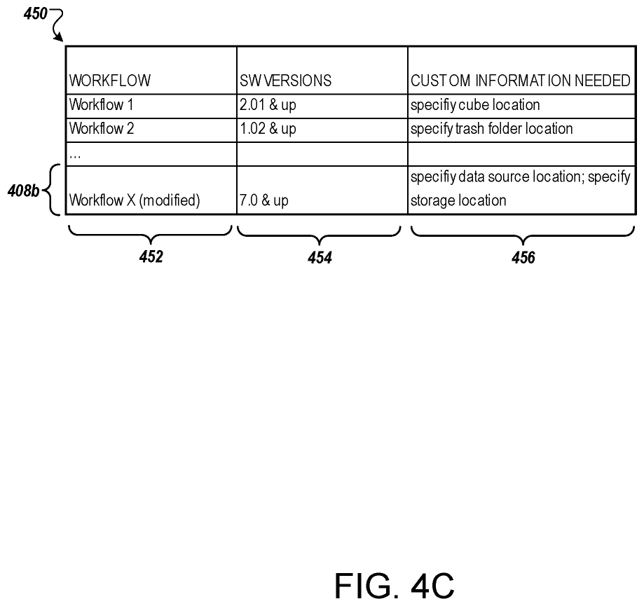

FIGS. 4A-4C depict a diagram that illustrates an example system 400 for validating and publishing workflows from remote environments, such as third-party servers. The system 400 includes a workflow publishing server 410 having a data storage 412. The system 400 is able to receive one or more workflows from various systems over a network 440. The system 400 may modify the one or more workflows. The system 400 may publish the one or more modified workflows, making the one or more modified workflows available to other servers.

The workflow publishing server 410 may perform validation testing on each of the received workflows. Upon validation of a workflow, the workflow publishing server 410 may publish the workflow. The workflow publishing server 410 may provide the published workflow to a server in response to a request. The workflow publishing server 410 may recommend a published workflow for a particular server or for a user of a server.

In general, a workflow refers to a series of computer operations that can be performed on a server system. The workflows may be validated before being published. Published workflows may be organized into one or more workflow libraries 414.

Performance of one or more operations in the set of workflow operations may be conditional on the occurrence of particular events. A workflow may contain alternative or branching sets of operations, where one set of operations is performed over another set based on the conditions that were satisfied.

A user device 404 can be a computing device, such as a desktop computer, a laptop computer, a mobile phone, a smart phone, a personal digital assistants (PDA), a tablet computer, or other computing devices. The user device 404 can communicate with a first server 402 over, for example, the network 440.

The network 440 can include public and/or private networks and can include the Internet.

The workflow publishing server 410 may contain one or more computing devices. The workflow publishing server 410 communicates with the server 402 and a second server 430 over the network 440. The workflow publishing server 410 may communicate with the third-party servers 402 and 430 through respective application programming interfaces (APIs).

The data storage 412 includes workflow libraries 418 and a workflow listing 418. The data storage 412 may be memory, such as non-volatile memory.

The third-party servers 402 and 430 may each include one or more computing devices. The third-party servers 402 and 430 are remote with respect to the workflow publishing server 410. The third-party servers 402 and 430 may each be part of a cloud computing platform (e.g., Amazon Web Services (AWS), Microsoft Azure, and so on).

The techniques disclosed in this document can increase the efficiency and reliability of server systems. Workflow operations may be desirable for a server system in order to automate particular actions, to improve system performance, to improve system reliability, etc. By performing validation testing on the workflows prior to publishing, the system 400 reduces the likelihood of a server system experiencing any instability, loss of performance, or other errors as a result of executing a workflow. Accordingly, the system 400 improves the efficiency and reliability of server systems. In addition, by performing validation testing on the workflows prior to publishing, the system 400 reduces the likelihood that those workflows will need to later be modified by a server system and/or reduces the extent of modification that will be needed. Accordingly, the system 400 further improves the efficiency and reliability of server systems.

The techniques disclosed in this document can further improve server system efficiency through workflow recommendations. Workflow operations may be desirable for a server system in order to automate particular actions, to improve system performance, to improve system reliability, etc. By leveraging user actions for a particular server system, the system 400 can accurately recommend one or more published workflows for the particular server system. As such, the system 400 reduce or removes the need for a server system user to search through a listing of published workflows to determine which ones would be helpful. Additionally, by leveraging user actions, the system 400 can recommend workflows that are more applicable to the needs of a particular server system than a server system user may realize. Accordingly, the system 400 can further improve server system efficiency.

FIG. 4A also illustrates a flow of data, shown as stages (A) to (E), with each representing a step in an example process. Stages (A) to (E) may occur in the illustrated sequence, or in a sequence that is different from the illustrated sequence. For example, some of the stages may occur concurrently.

As shown in FIG. 4A, in stage (A), the process for receiving and publishing workflows from remote environments starts with the third-party user 406 creating a new workflow 408a (“Workflow X”). The workflow 408a includes three steps (e.g., separately identifiable actions).

The user 406 may indicate that the workflow 408a is meant to be published. The user 406 may indicate that the workflow 408a is meant to be published. Once the user 406 has indicated that the workflow 408a is meant to be published, the workflow 408a is sent from the user device 404 to the server 402. In some implementations, the user 406 can save the workflow 408a to the server 402 and later indicate that the workflow 408a should be published.

In some implementations, the user 406 generates metadata for the workflow 408a. This metadata may include for example a description of the workflow, a category or result of the workflow, and/or an indication of the server system software or software version that the workflow is compatible with.

In stage (B), the server 402 sends the workflow 408a to the workflow publishing server 410 over the network 440. In some implementations, the server 402 also sends metadata associated with the workflow 408a to the workflow publishing sever 410.

In stage (C), upon receiving the workflow 408a, the workflow publishing server 410 initiates validation testing on the workflow 408a. The workflow publishing server 410 may provide the workflow 408a to a workflow testing module 420. The workflow testing module 420, as described in more detail below with respect to FIG. 4B, may perform a series of tests on the workflow 408a. These series of tests are fully automated. Based on the results of one or more of the tests in the series of tests, the workflow publishing server 410 or an administrator having access to the workflow publishing server 410 may modify the workflow 408a. The workflow 408a may be tested and modified a number of times until various conditions are met such that the workflow 408a passes all of the tests.

In some implementations, upon receiving the workflow 408a, if no metadata, such as a description or a tag, associated with the workflow 408a is received from the server 402, the workflow publishing server may send a notification to the server 402 requesting that the user 404 or another user of the server 402 provide metadata, such as a description or a tag, for the workflow 408a.

In some implementations, after the workflow 408a is modified, the entire series of tests are restarted. In some implementations, after the workflow 408a is modified, testing is resumed such that the testing of the workflow 408a begins with the last test performed (e.g., testing resumes with the test that triggered the modification).

In order to perform validation testing on the workflow 408a, the workflow publishing server 410 may generate one or more server environments for testing the workflow 408a. The one or more server environments may include a sandbox environment to be used for all or part of the validation testing of the workflow 408a. In general, a sandbox environment is a testing environment and may encompass a number of different configurations, including on-premises environments or cloud-based environments. The sandbox environment is typically isolated from other systems such that if errors or unexpected behavior occur, the result will not affect other systems or users of production systems. For example, the sandbox can be a testing environment that isolates workflows being tested and software that they affect from the production environment or data repository. The server environment may be an on-premises environment, a virtual, cloud-based environment, or a combination of one or more on-premises environments and cloud-based environments. The server environment may be created through a virtual machine model, paravirtual machine model, or through OS-level virtualization.

The validation testing module 420 may test the workflow 408a for functionality or effectiveness to ensure that the workflow 408a works as intended. For example, the validation testing module 420 may test to make sure that each step within the workflow 408a executes without an error and that the intended result of the workflow 408a occurs.

The validation testing module 420 may test the workflow 408a for server system stability. For example, the workflow publishing server may indicate that a workflow needs to be modified if testing of the workflow frequently results in the server environment crashing.

The validation testing module 420 may test the workflow 408a for performance or system efficiency. Testing for performance or system efficiency may include determining the amount of resources used by the workflow 408a, determining if the workflow 408a executes with sufficient speed (e.g., by comparing the execution time to a threshold time), determining if the workflow 408a can be optimized (e.g., through modification to the workflow 408a), determining if the workflow 408a uses outdated libraries, determining if the workflow 408a has any unnecessary code and/or dependencies, etc. In addition, during performance or system efficiency testing, the validation testing module 420 may vary the configuration parameters of the server environment used for testing and the input parameters of a workflow to ensure that the workflow perform adequately under various scenarios. For example, the validation testing module 420 may vary the software version of the server environment used for testing to determine which software versions that a workflow is compatible with.

The validation testing module 420 may test the workflow 408a for security. In testing for security, the server environment used for testing may be a sandbox environment. During security testing, the workflow monitoring server 410 may identify and log each element that the workflow 408a touches and classify those different interactions. These elements may include data sources, data fields, outside systems, etc. Classifications for interactions may include a safe or secure classification, an unsafe or insecure classification, and an unknown classification. The workflow monitoring server 410 may remove unsafe or insecure aspects from the workflow 408a, require administrator confirmation or modification of the workflow 408a, and/or label the workflow 408a with a warning. As an example, the validation testing module 420 may test to ensure that none of the steps or actions performed by a workflow include accessing forbidden information, confidential information, and/or customer information. As another example, the validation testing module 420 may test to ensure that none of the steps or actions performed by a workflow include sending to a location or storing information at a location unknown to the user.

The validation testing module 420 may test the workflow 408a for applicability. In testing for applicability, the workflow monitoring server 410 may identify the situations and system configurations (e.g., software versions) that the workflow 408a can be used with. In testing for applicability, the workflow monitoring server 410 may identify specific data sources, files, destinations, etc. and replace them with a field for a third-party user to specify their own data source, file, destination, etc. In some implementations, applicability testing is part of the performance testing of a workflow.

In some implementations, when the validation testing module 420 tests the workflow 408a for performance, the workflow monitoring server 410 may calculate a relative performance index (RPI) for the server environment. The RPI is a normalized performance value that is independent (or nearly independent) of the characteristics of a particular server environment. The RPI indicates the best configuration settings tested. The workflow monitoring server 410 calculate an RPI for the server environment for every configuration of the server environment tested. The RPI is a normalized performance value that is independent (or nearly independent) of the characteristics of a particular server environment. In these implementations, in order to pass the performance test, the workflow 408a may need reach a particular RPI. If the particular RPI is not met during testing, the workflow 408a may need to be modified until testing indicates that the requisite RPI is met. If the RPI is never met despite exhaustive testing of varying server environment configuration parameters and workflow input parameters, the workflow publishing server 410 may determine and/or the validation testing module 420 may indicate that the workflow 408a should not be published.

In some implementations, when the validation testing module 420 tests the workflow 408a for performance, the workflow monitoring server 410 may leverage a machine learning network to select configuration parameters for the server environment and/or input parameters of the workflow 408a. By leveraging a machine learning network, the workflow monitoring server 410 may be able to reduce the time and resources spent testing the workflow 408a. For example, a machine learning network may be able to indicate that increasing the value of a particular parameter is more likely to lead to better performance than decreasing the value of that parameter. Accordingly, leveraging a machine learning network may be able to help avoid performing exhaustive testing on and/or with the workflow 408a.

In some implementations, when the validation testing module 420 tests the workflow 408a for security, the validation testing module 420 or an administrator with access to the workflow publishing server 410 may indicate that a particular action and/or step within the workflow 408a needs to be associated with a security permission. For example, if a workflow calls for executing a program on the server system, the validation testing module 420 or an administrator may flag the step as needing administrator permissions. In this example, the workflow can then be modified so as to require administrator permissions in order to perform the workflow and/or that particular step of the workflow.

In some implementations, the workflow monitoring server 410 can modify the workflow 408a so that it meetings the validation testing criteria. These modification may be automated. For example, if it is determined during testing that a workflow or a part of a workflow is too specific (e.g., retrieves a specific file), the workflow monitoring server 410 may generalize the workflow (e.g., by replacing that file with a field which a user must enter). As another example, if it is determined during testing that a workflow or a part of a workflow is unstable, the workflow monitoring server 410 may automatically remove the offending step or action or replace it with a more stable step or action. If the workflow monitoring server 410 makes an automatic modification to the workflow 408a, the validation testing to the workflow 408a may be restarted or resumed with the modified version of the workflow 408a.

During validation testing, metadata may be generated for the workflow 408a. This metadata may be provided by an administrator having access to the workflow publishing server 410. For example, an administrator may provide a description for a workflow. This metadata may be provided by the workflow publishing server 410 itself. For example, during performance testing of a workflow, the workflow publishing server 410 may determine the software compatibility of the workflow and, based off of this determination, provide an indication of the compatible software versions as part of the workflow's metadata. The metadata may be used to help third-party users search for and identify workflows that may be useful for their particular needs.

The metadata may include what permissions are needed for the workflow 408a, what software versions the workflow 408a works with, what additional fields or customizations are needed for the workflow 408a (e.g., a user must provide a server address, a trash emptying time period/frequency, a maximum trash size threshold limit, etc.), what resources the workflow 408a may access, and/or a summary of the types of steps in the workflow 408a (e.g., a workflow classification) or a result of the workflow 408a. As will be described in more detail with respect to FIG. 2, the workflow monitoring server 410 may use a summary of the types of steps in the workflow 408a or a result of the workflow 408a to recommend the workflow 408a to particular third-party servers and/or users.

In some implementations, the metadata generated may be in addition to metadata that was received from the server 402. For example, the workflow publishing server 410 may have received metadata including a description for a workflow from a third-party server and may have received input from an administrator indicating a categorization for the workflow. In this example, the workflow publishing server 410 may combine both input in order to generate metadata for the workflow. In these implementations, the combination of the generated metadata and the received metadata may form the metadata outputted by the validation testing module 420.

In some implementations, the metadata generated replaces all or part of received metadata. For example, the workflow publishing server 410 may have received metadata including a description for a workflow from a third-party server but later received a different description from an administrator. In this example, in generating the metadata for the workflow, the workflow publishing server 410 may overwrite the description from the third-party server with the description provided by the administrator.

Once a workflow has passed the series of tests performed by the validation testing module 420, the validation testing module 420 may output the modified workflow 408b and the metadata 422 associated with the modified workflow. As shown, the steps of the modified workflow 408b are different than the steps of the workflow 408a. The modified workflow 408b no longer includes step 2 as this step was automatically removed by the workflow monitoring server 410 for being classified as insecure during security testing. In addition, step 3 of the modified workflow 408b is now different than step 3 of the workflow 408b. The modified workflow 408b also contains an additional step, step 4.

The metadata 422 for the modified workflow 408b contains a description of the workflow 408b, a categorization (e.g., purpose) or result (e.g., goal) of the workflow 408b, an indication of software versions that are compatible with the workflow 408b, and an indication of a library designation for the workflow 408b.

In stage (D), upon the workflow 408b passing the validation testing, the workflow publishing server 410 adds the workflow 408b to a workflow library 416 (“Workflow Library Y”) of workflow libraries 414. In the library 416, the workflow 408b is associated with the metadata 422.

When the workflow publishing server 410 updates the workflow library 416 to include the workflow 408b, it may generate or update the workflow listing 418 so that it too contains the workflow 408b. The workflow listing 418 may include all workflows contained in all the libraries of the workflow libraries 414. The workflow listing 418 may include all workflows from a particular library, such as the workflow library 416. When the workflow listing 418 includes all workflows from a particular library, there may be a workflow listing for each library. The workflow library 416 may correspond with a particular third-party server, such as the server 430. As such, where the workflow listing 418 includes all workflows from a particular library, the workflow listing 418 may also correspond with a particular third-party server, such as the server 430.

The workflow listing 418 may include information about each of the workflows within the workflow listing 418. This information may include metadata, such as a name of the workflow, a purpose of the workflow or an error that the workflow addresses, a description of the operations within the workflow (e.g., which may also include required conditions for operation performance), a list of persons who can access the workflow, security permissions for the workflow, and software versions that the workflow is compatible with.

In stage (E), as a result of updating the workflow listing 418, the workflow publishing server 410 pushes a workflow listings 418a to the server 430. The workflow listing 418a may be the same as workflow listing 418. The workflow listing 418 may be modified for the server 430, resulting in the workflow listing 418a. For example, the workflow listing 418a may contain only those workflows found in the workflow listing 418 that are compatible with the server system and/or server software of the server 430.

In FIG. 4B, the workflow 408a undergoes validation testing and modification by the validation testing module 420 of the workflow monitoring server 410. As shown, the validation testing module 420 starts with the workflow 408a. The workflow 408a contains a first step to get time, a second step to access the user table, and a third step to make an application programming interface (API) call to a data source to retrieve data if Z time has passed.

During a first series of tests 424a (“TEST 1”), the validation testing module 420 tests the workflow 408a. The testing of the workflow 408a begins with testing the first step of the workflow 408a. The results of the testing on the first step show that the action(s) associated with the first step are safe and no permissions are needed. As a result of the first step being classified as safe as is, no modifications are needed. Because this step is classified as safe and/or because no modifications are required for this step, the validation testing module 420 proceeds to test the second step. The results of the testing on the second step show that the step is unsecure because it is an attempt to access forbidden (or confidential information) and is against the system 400's privacy policy. The workflow monitoring server 410 may automatically remove the second step, suggest to an administrator that the second step be removed and await confirmation, and/or label the second step with a security warning. As a result of the workflow 408a needing modification, the series of tests 424a ends so that the workflow 408a can be modified.

Here, the workflow monitoring server 410 automatically removes the second step of the workflow 408a and generates a workflow 408a′ as a result. A second series of tests 424b (“TEST 2”) is initiated on the workflow 408a′ by the validation testing module 420. During the series of tests 424b, the testing of the first step of the workflow 408a′ may be carried out. Alternatively, the testing of the first step of the workflow 408a′ may be skipped since the workflow 408a and the workflow 408a′ have the same first step and that step was classified as safe during the series of tests 424a. There is no testing of the second step since this step has been removed.

The results of the testing on the third step during the series of tests 424b show that the action(s) associated with the third step are secure but recommends that a requirement for administrator security permissions be added to third step. The workflow monitoring server 410 may automatically add this requirement to the third step, suggest to an administrator that these requirements be added to the third step and await confirmation, and/or label the third step with a security warning. As a result of the workflow 408a′ needing modification or there being a suggested modification, the series of tests 424b ends so that the workflow 408a′ can be modified.

Here, the workflow monitoring server 410 automatically modifies the third step of the workflow 408a′ and generates a workflow 408a″ as a result. A third series of tests 424c (“TEST 3”) is initiated on the workflow 408a″ by the validation testing module 420. During the series of tests 424c, the testing of the first step of the workflow 408a″ may be carried out. Alternatively, the testing of the first step of the workflow 408a″ may be skipped since the workflow 408a, the workflow 408a′, and the workflow 408a″ have the same first step and that step was classified as safe during the series of tests 424a. There is no testing of the second step since this step has been removed.

The results of the testing on the third step during the series of tests 424c now show that the action(s) associated with the third step are safe and no modification is needed. Having retrieved data during the third step, functionality testing and/or applicability testing during the series of tests 424c may reveal an error because the workflow doesn't do anything with the retrieved data. The workflow monitoring server 410 note that an error has occurred, that a fourth step is required, a modification to the third step is required, a security warning, etc. As a result of the workflow 408a″ needing modification or there being a suggested modification, the series of tests 424c ends so that the workflow 408a″ can be modified.

Here, an administrator having access to the workflow monitoring server 410 uses the workflow monitoring server 410 to add a step four to the workflow 408a″. As a result of the modification, a workflow 408b is generated. A fourth series of tests (not shown) may be performed on the workflow 408b to confirm that the workflow 408b passes each of the tests and does not need to be modified. Upon passing the series of tests, the workflow monitoring server 410 publishes the workflow 408b by adding it to the library 416 in the data storage 412.

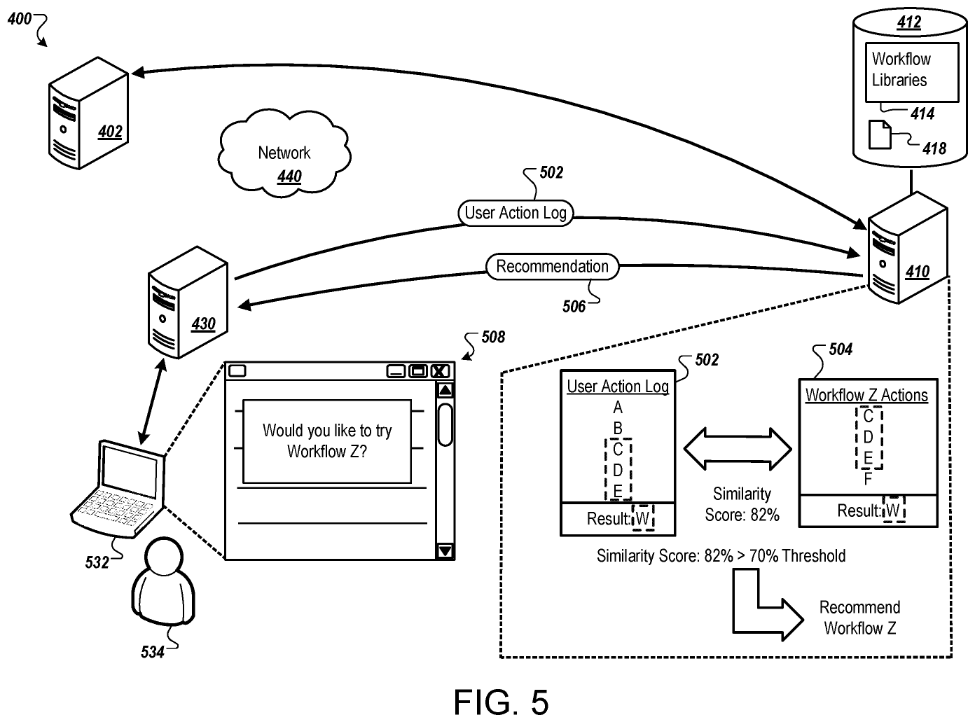

In FIG. 4C, a table 450 displays applicability data associated with a list of workflows 452, including the workflow 408b. Here, the applicability data for each of the workflows in the list of workflows 452 includes the server software versions 454 that the workflows are compatible with and custom information 456 that needs to be entered by a server user (e.g., the third-party user 406 shown in FIG. 4A, or the third-party user 534 as shown in FIG. 5). This applicability data may be automatically generated by the workflow monitoring server 410. This applicability data may be partially generated by the workflow monitoring server 410. For example, the workflow monitoring server 410 may recognize specific data sources, files, and/or destinations used by a workflow and mark them for modification by a system 400 administrator.

As shown, a first workflow (“Workflow 1”) is compatible with server software versions 2.01 and up, and requires that a server user specify a data cube location. A second workflow (“Workflow 2”) is compatible with server software versions 1.02 and up, and requires a server user to specify a trash folder location. The workflow 408b is compatible with software versions 7.0 and up, and requires a server user to specify a data source or a location of a data source and to specify a storage location for the retrieved data.

FIG. 5 is a diagram that illustrates example process for recommending a published workflow to the server 430. The process for recommending a workflow uses the system 400 as described above with reference to FIGS. 4A-4C.

As shown, the workflow monitoring server 410 may receive a user action log 502 from the server 430. The user action log 502 may be associated with a third-party user 534 of the server 430. The user action log 502 may be sent to the workflow monitoring server 410 over the network 440.

After receiving the user action log 502, the workflow monitoring server 410 may determine workflows within the workflow libraries 414 and/or the workflow listing 418 that are sufficiently similar to actions contained within the user action log 502. The workflow monitoring server 410 may compare the user action log 502 with every workflow within the workflow libraries 414 and/or the workflow listing 418.

Alternatively, in some implementations, the workflow monitoring server 410 determines one or more results either contained in the user action log 502 or arising from the actions contained in the user action log 502, and compares these one or more results with the results of each of the workflows (contained in the metadata associated with those workflows) within the workflow libraries 414 and/or the workflow listing 418. In these implementations, the workflow monitoring server 410 will only perform a detailed comparison between the user action log 502 and those workflows that have results either matching the one or more results of the user action log 502 or sufficiently similar to the one or more results of the user action log 502.

As shown, the workflow monitoring server 410 compares the user action log 502 with a workflow 504 (“Workflow Z”). The workflow monitoring server 410 determines that three steps within the workflow 504 are also found in the user action log 502. The workflow monitoring server 410 also determines that a result of the user action log 502 matches the result of the workflow 504. The workflow monitoring server 410 may make this determination by obtaining the metadata associated with the workflow 504, retrieving the results of the workflow 504 from its metadata, and comparing those results with the one or more results of the user action log 502.

Based off of the comparison of the user action log 502 with the workflow 504, the workflow monitoring server 410 determines a similarity score of 82% between the user action log 502 and the workflow 504. Because the similarity score of 82% is greater than a threshold score of 70%, the workflow monitoring server 410 determines that the workflow 504 should be recommended to the server 430 and/or the user (e.g., the third-party user 534) associated with the user action log 502. In making this determination, the workflow monitoring server 410 generates a recommendation 506 to be sent to the server 430. The recommendation 506 may be in the form of a notification. The recommendation 506 may contain an indication of the workflow 504. The recommendation 506 may contain metadata associated with the workflow 504, including, for example, a description of the workflow, the results of the workflow, the compatibility of the workflow 504, etc.

In some implementations, the workflow monitoring server 410 will check to ensure that the workflow 504 is compatible with the server 430 prior to sending the recommendation 506. For example, the workflow monitoring server 410 may compare the software version of the server 430 with the software versions that the workflow 504 is compatible with as indicated by the metadata associated with the workflow 504.

Alternatively, in some implementations, ensuring compatibility between the server 430 and the workflow 504 may be part of the recommendation process during comparison of the user action log 502 and the workflow 504.

The workflow monitoring server 410 provides the recommendation 506 to the server 430 over the network 440. When the third-party user 534 logs in to the server 430 through a user device 532, the user 534 is presented with the recommendation 506 in the form of a notification on an interface 508 of the user device 532. If the user 534 selects the notification, the workflow 504 may be sent in response from the workflow monitoring server 410 to the server 430.

The user 534 may be able to install the received workflow 504 in server 430, run the received workflow 504, modify the received workflow 504, etc.

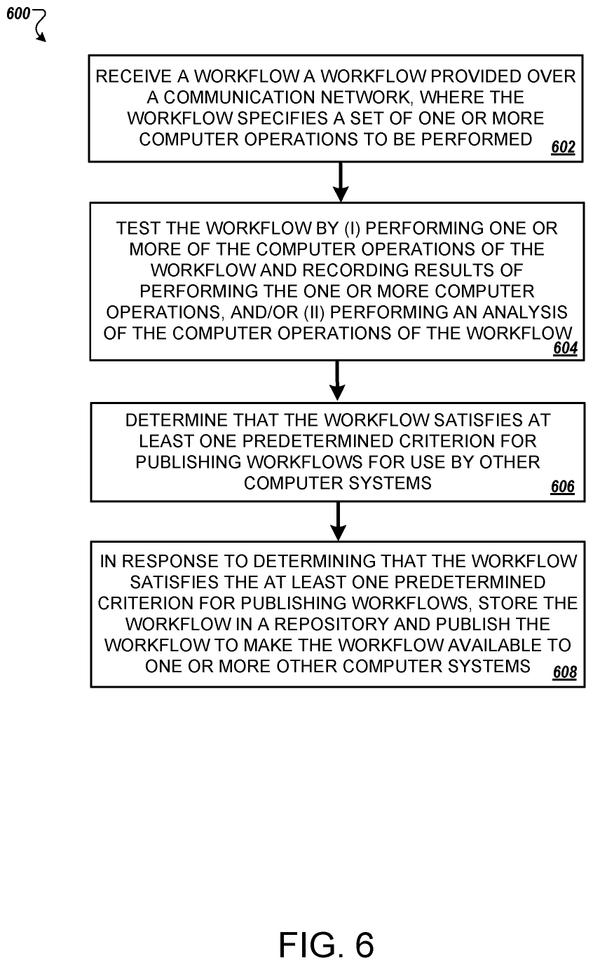

FIG. 6 is a flow diagram that illustrates a process 600 for validating and publishing a workflow. The process 600 can be performed by one or more computers as discussed above. For example, the process 600 can be performed by the workflow publishing server 410 shown in FIG. 4A and FIG. 5.

The process 600 includes receiving a workflow provided over a communication network, where the workflow specifies a set of computer operations to be performed (602). With respect to FIGS. 4A-5, the workflow publishing server 410 may receive the workflow over the network 440. The workflow may be generated or submitted by a user. Alternatively, the workflow and/or its computer operations may be automatically determined, for example, automatically generated using artificial intelligence. As an example, a machine learning model (e.g., a trained neural network) or a software program may combine operations that are commonly performed together (e.g., as indicated by user action logs) to form a workflow.

The process 600 includes testing the workflow (604). For example, the testing can include (i) performing one or more of the computer operations of the workflow and recording results of performing the one or more computer operations, and/or (ii) performing an analysis of the computer operations of the workflow. With respect to FIGS. 4A-5, the workflow publishing server 410 may identify and log errors produced as a result of performing one or more of the computer operations of the workflow. Examples of test results that may be tracked include data generated by the operations of the workflow, a list of hardware or software resources involved in performing the operations, manner in which resources were used (e.g., amount of time or capacity used, or access type, such as read, write, execute, etc.), indications of incompatible software or software versions, attempted actions that could not be successfully performed (e.g., for being impermissible or unauthorized), crashes, missing or inaccessible locations, performance measures (including indications when observed performance does not meet minimum performance thresholds), instances of missing data or operations that are required to perform an operation of the workflow, etc. The workflow publishing server 410 may also record observed performance changes and/or configuration changes caused by performing operations of the workflow. The workflow publishing server 410 may run operations of the workflow at a particular server environment, such as an isolated, “sandboxed” testing environment where the workflow will not affect the operation of the workflow publishing server 410. Among other items, the workflow publishing server 410 may track load times, render times, and/or reporting times through the performance of the one or more computer operations. The testing may assess and record any of various types of performance measures, including any of compatibility, response time, bandwidth, throughput, capacity, reliability, availability, response time, latency, resource utilization, and more.

The workflow publishing server 410 may further record the data produced by the performance of one or more computer operations of the workflow. This can include output data generated by the workflow, log data indicating actions of the workflow, and so on. As an example, with respect to FIG. 4B, the workflow publishing server 410 may, as a result of performing the steps of the workflow 408a, record the time retrieved from performing the first step of the workflow 408a and the data retrieved from performing the third step of the workflow 408a. Because the attempted performance of the second step of the workflow 408a resulted in the error, the workflow publishing server 410 would record the error but not the user table as it was never retrieved. In some cases, the workflow publishing server 410 may compare the data produced by the one or more operations to expected data, such as predicted or previously recorded output of the workflow, to determine if the operations and/or the workflow can be performed successfully and reliably under different conditions.

In some cases, testing the workflow includes creating a testing environment (e.g., a virtual machine, a cloud-based environment, etc.) with which to perform some or all of the computer operations of the workflow. For example, with respect to FIGS. 4A-5, the workflow publishing server 410 may generate a sandboxed server environment for performing the computer operations of the workflow. The configuration of the generated server environment may be altered between different testing iterations, optionally with randomized settings or randomized changes, so that multiple tests are performed with different configurations. Alternatively, the configuration of the server environment for testing the workflow may be based on predetermined sets of configuration settings, such as known configuration settings of computer systems, especially systems likely to request the workflow or benefit from the workflow. In any case, multiple rounds of testing can be performed to determine effects of the workflow in different environments and with different configurations.

In some cases, testing the workflow includes performing each operation of the workflow to determine if each operation can be successfully performed. For example, the workflow publishing server 410 shown in FIG. 4A may test the workflow 408a by attempting to perform each step in the workflow 408a. An operation may be successfully performed if it meets particular criteria as discussed in more detail below, such as not resulting in any (or particular) errors, meeting specified performance metrics, producing expected data, etc.

With respect to FIG. 4A, the workflow publishing server 410 may perform an analysis of the one or more computer operations. For example, the workflow publishing server 410 may parse instructions specifying the one or more operations to identify the types of operations instructed resources (e.g., files, data sources, data elements, software objects, hardware elements, interfaces, and so on) that the operations interact with. For example, the workflow publishing server 410 can parse through the workflow to record particular commands, API calls, content, metadata, etc. of each of the one or more operations, and data sources, data fields, outside systems such as servers, etc. that the one or more operations interact with. Using these identified elements, the workflow publishing server 410 may determine the changes that would be made by performing an operation.

The workflow publishing server 410 may use the identified elements involved in a workflow to identify errors or other issues that are likely to occur if the operation is performed, e.g., that might prevent the successful operation of the workflow. For example, the elements may include locations that are inaccessible or unauthorized. In response, the workflow publishing server 410 may update the location to one that is accessible or authorized, may modify the operation to require particular authorization, or may remove the corresponding operation from the workflow. The workflow publishing server 410 can also use the identified elements to predict the data produced, e.g., the outputs, of the workflow. In testing the workflow, the workflow publishing server 410 can compare the predicted data produced to the observed data produced during the performance of the one or more operations to determine if the workflow is able to operate successfully. Accordingly, the workflow publishing server 410 can use the elements to determine if the operations and, therefore, the workflow, will achieve the result(s) it is intended to achieve.

Based on the analysis, the workflow publishing server 410 may classify the workflow. For example, the workflow publishing server 410 may classify a workflow according to the purpose or effect of the workflow, such as whether it is used to install patches, change settings, fix causes of errors, optimize performance, resolve incompatibilities, resolve conflicts (e.g., between configuration settings, software versions, files, etc.) correct dependencies (e.g., by updating references to files or data, or providing files or data that were missing or inadequate), refresh caches, optimize data sets, monitor performance, etc. The workflow publishing server 410 may determine the use of the workflow based on the types of operations in the workflow, previous recorded uses of the workflow, metadata corresponding to the workflow (e.g., provided by a user), and/or the observed or predicted output of the workflow.

In some implementations, testing the workflow does not include performing any operations of the workflow. For example, with respect to FIG. 4A, the workflow publishing server 410 may simply analyze the operations of the workflow and use the results of the analysis to predict quality, safety, reliability, and/or performance of the workflow.

Testing of the workflow may be carried out, e.g., by the workflow publishing server 410, to ensure that minimally acceptable level of quality, safety, reliability, and/or performance is achieved across one or more computer systems when the workflow is performed. In some cases, the testing is performed with a particular computer system that is to receive the workflow in mind so as to ensure adequate quality, safety, reliability, and/or performance of the workflow when used in that particular computer system. Alternatively, testing may be performed to ensure adequate quality, safety, reliability, and/or performance of the workflow across various different computer systems.

The process 600 includes determining that the workflow satisfies at least one predetermined criterion for publishing workflows for use by other computer systems (606). As an example, with respect to FIG. 4A and FIG. 5, the workflow publishing server 410 may consider a workflow for publication if testing indicates that performing the workflow: does not result in any (or a particular subset) of errors; meets predetermined performance thresholds; produces expected data (e.g., predicted or previously observed outputs); meets compatibility requirements (e.g., compatible with the most recent OS software versions); and/or meets security requirements (e.g., the workflow does not include impermissible operations such as the collection of personal or confidential data. Similarly, a criterion for publication may be that the workflow includes authentication requirements for the operations in the workflow, such as administrator authentication being required if any software will be added to, removed from, or modified on a computer system that is to receive the workflow; etc.). If any of these requirements or prequisites are not met, the workflow publishing server 410 may determine that the workflow, in its current form, should not be published. Depending on the type and severity of issue identified, e.g., based on which criterion is not satisfied and whether that failure can be corrected, the system may determine to modify the workflow and publish the modified workflow or to block publication entirely.

The at least one predetermined criterion may be specified by a user or by the workflow publishing server 410 shown in FIG. 4A. In defining the at least one criterion, the workflow publishing server 410 may use a machine learning model (e.g., a trained neural network) to set a threshold value(s) for the at least one criterion in order to ensure adequate quality, safety, reliability, and/or performance of the workflow. The at least one criterion may be applicable to all (or various) computer systems, or, instead, to a particular computer system that has requested or is otherwise likely to receive the workflow. For example, the workflow publishing server 410 may receive additional criteria or modified criteria from the second server 430. Similarly, the workflow publishing server 410 may generate or update the at least one criterion to account for the second server 430 based on a determination that the second server 430 has requested or is otherwise likely to receive the workflow.

In some cases, if it is determined that a workflow does not satisfy one or more of the at least one predetermined criteria, the workflow may be modified to satisfy the at least one predetermined criteria. For example, with respect to FIG. 4A, if the workflow publishing server 410 determines that a workflow includes an operation that presents an unacceptable security risk (e.g., collects personal data and uploads to an unauthorized server), then the workflow publishing server 410 may remove the operation from the workflow. The workflow publishing server 410 may further remove or modify any other operations in the workflow that relied on the removed operation. The workflow publishing server 410 may remove operations from the workflow for other reasons as well, such as if the operation violates policies set by a computer system that is to receive the workflow or policies of all compatible computer systems. Operations that are likely to, or consistently, result in errors, crashes, or poor performance may also be removed.

Similarly, if the workflow publishing server 410 determines that an operation in the workflow generally or always requires a particular level of authentication (e.g., based on documents, logs, or other data from computer systems that have previously requested workflows and/or are registered to receive workflows), the workflow publishing server 410 may modify the workflow to require the corresponding level of authentication to perform the workflow, or may flag particular operations of the workflow as requiring the corresponding level of authentication. These operations that require authentication may include those that may present a security risk, such as, for example, the collection of personal or confidential data, the upload of data to remote (and/or unrelated) server systems, the installation of software, the removal of software, the modification of software, etc. For example, the workflow publishing server 410 may modify a workflow such that a particular operation of modifying configuration settings is flagged such that it cannot be performed without an administrator's authentication. If a user who is not administrator attempts to initiate the workflow, the workflow may prompt the user for administrator credentials or may perform the other operations of the workflow that are not flagged.

Similar to operations that require a particular level of authentication, the workflow publishing server 410 may modify the workflow to include user or administrator confirmation prior to performing the workflow or a particular operation of the workflow. The workflow publishing server 410 may make this modification based on a determination that particular types of operations generally or always require user or administrator confirmation (e.g., based on documents, logs, or other data from computer systems that have previously requested workflows and/or are registered to receive workflows), such as a the shutdown, restart, or suspension of the computer system.

In some implementations, multiple tests are performed and one or more changes are made to the workflow before the at least one predetermined criterion is satisfied. For example, based on the results of multiple tests, the one or more computers may alter the workflow and/or metadata for the workflow based on the test results until each of that at least one predetermined criterion for publishing workflows is satisfied.

In some cases, if it is determined that a workflow does not satisfy one or more of the at least one predetermined criteria, a notification may be sent to the computer system that provided the workflow. For example, with respect to FIG. 4A, the workflow publishing server 410 may generate and send a notification to the first server 402 that indicates the reasons why the workflow cannot be published, and/or a request for a corrected workflow.

The process 600 includes, in response to determining that the workflow satisfies the at least one predetermined criterion for publishing workflows, storing the workflow in a repository and publishing the workflow to make the workflow available to one or more other computer systems (608). As an example, with respect to FIG. 4A, once the workflow publishing server 410 determines that the workflow 408b can be published, the workflow publishing server 410 may store the workflow 408b in the data storage 412 as part of the workflow libraries 414. The data storage 412 may be local storage with respect to the workflow publishing server 410, such as a local database or local file server, or may be remote, such as a remote database, file server, or cloud storage.

As an example, with respect to FIG. 4A, the workflow publishing server 410 may make the workflow available to one or more computer systems, such as the first server 402 and/or the second server 430. For example, the workflow publishing server 410 may show that the workflow is now available by placing it in a catalog of available workflows. The catalog may be stored in a shared folder, e.g., hosted by the workflow publishing server 410, or may be sent to various computer systems that are registered to receive workflows. The workflow publishing server 410 may make the workflow available over a network. For example, the workflow publishing server 410 may host the workflow by placing it in a shared folder of the data storage 412, or may send the workflow to a particular location on a remote file server or cloud storage that is accessible by the one or more computer systems. In some cases, the workflow publishing server 410 provides the workflow to one or more computer systems. For example, the workflow publishing server 410, upon determining that the workflow satisfies the at least one criterion, may transmit a copy of the workflow to the second server 430.

As an example, the workflow publishing server 410 may generate or update a catalog of available workflows. The catalog may be applicable to multiple computer systems and include, for example, all workflows in the workflow libraries 414. Alternatively, the catalog may be specific to a particular computer system such as the second server 430 and include only those workflows in the workflow libraries 414 that are compatible with the second server 430 (e.g., based on software compatibility). The workflow publishing server 410 may place the catalog at location that accessible corresponding computer systems, such as in a shared folder hosted by the workflow publishing server 410. Additionally or alternatively, the workflow publishing server 410 may generate and transmit a notification to one or more computer systems that indicates that the workflow is available. The notification may include the newly generated or updated catalog. The notification may be in the form of a recommendation, e.g., that is sent by the workflow publishing server 410 to those computer systems that are compatible with the workflow, have expressed interest in similar workflows, or whose user action logs indicate frequent occurrences of operations that match or are similar to the operations in the workflow.

As another example, with respect to FIG. 4A, the workflow publishing server 410 may send the workflow to the second server 430 in response to determining that the workflow satisfies the at least one criterion. The workflow publishing server 410 may send the workflow to the second server 430 based on having received a request for the workflow (or having previously received a request for a similar workflow) from the second server 430, a determination that the workflow is compatible with the second server 430, and/or a determination that the workflow is recommended for the second server 430 (e.g., based on user action logs of the second server 430 indicating frequent occurrences of operations that match or are adequately similar to the operations in the workflow).

In some cases, the process 600 includes recommending the workflow to a computer system. For example, with respect to FIG. 5, the workflow publishing server 410 may recommend the workflow and/or one or more additional workflows to the first server 402 in response to a request for a recommendation, or in response to the publication of the workflow. The request for a recommendation may include an indication of the type of the problem that the workflow must solve, a classification of workflow sought, a list of operations that must be performed, a result that must be produced, etc. The workflow publishing server 410 may use data corresponding to the first server 402, such as previously requested workflows, data included in the recommendation request, and/or user action logs, to determine that the workflow should be recommended.

In making a recommendation, the workflow publishing server 410 may use the data corresponding to the first sever 402 to score and rank multiple workflows. For example, the workflow publishing server 402 may identify, based on a provided problem for which the workflow is being sought, a group of workflows that correspond to that problem (e.g., that are commonly used to address the particular problem or similar problems). The workflow publishing server 402 may proceed to compare each of the workflows in the group with user action logs of the first server 402 to identify the workflows containing operations that are most similar to or match the operations in the user action logs. The workflow publishing server 402 may determine a similarity score for each of the workflows, and may apply a minimum similarity threshold to eliminate workflows from recommendation that are not adequately similar. The remaining workflows may be ranked based on their similarity score. The workflow publishing server 402 may proceed to generate a notification to be transmitted to the first server 402 or to a particular user of the first server 402 (e.g., an administrator) that indicates the recommended workflows, their rankings, and/or their similarity scores.

In some implementations, a workflow can be received, stored, and published in the form of a workflow module. The workflow module may be a file, a combination of multiple files, a data package, or other data. As an example, with respect to FIGS. 1A-1B, the workflow module 118a may define a particular workflow, e.g., Workflow 1 for patching. The example of workflow module 118a has instructions for the client device 122 (and/or the server 120) to perform a set of operations related to patching (e.g., updating) software.

The workflow module may specify the set of operations to be performed, along with other related data, such as rules, settings, prerequisites or requirements for running the workflow, conditions for initiating the workflow, and so on. In some implementations, the workflow module may include executable code such as, an executable file or a data package containing multiple executable files. The workflow module may be executable by a computing device that is to receive the workflow module and/or that is to perform the set of operations indicated by the workflow module. For example, with respect to FIGS. 1A-1B, the workflow module 118a may be an executable file that can be executed by the client device 122 (and/or the server 120). Alternatively, the workflow module 118a may be a data package containing multiple executable files that can be executed by the client device 122 (and/or the server 120).

The workflow module may be interpretable, such as an interpretable file or data package containing multiple interpretable files. For example, with respect to FIGS. 1A-1B, the workflow module 118a may be interpretable. That is, after receiving the workflow module 118a, the client device 122 (and/or the server 120) may be capable of interpreting the contents of the workflow module 118a to perform the corresponding set of operations. As an example, the workflow module 118a may include multiple identifiers each corresponding to a particular operation. The client device 122 may use these identifiers to look up executable files to perform the operations.

Workflow modules can be accessed from local storage or from remote storage (e.g., on a cloud computing system). A computer system may receive a workflow module over a communication network, such as the Internet. A computer can access a workflow module by requesting the workflow module and receiving the workflow module. For example, with respect to FIGS. 1A-1B, the client device 122 or the server 120 can send a request for the workflow module to the workflow publishing server 110. In response, the workflow publishing server 110 may provide the requested workflow module to the server 120 and/or to the client device 122.

A number of implementations have been described. Nevertheless, it will be understood that various modifications may be made without departing from the spirit and scope of the disclosure. For example, various forms of the flows shown above may be used, with steps re-ordered, added, or removed.

Embodiments of the invention and all of the functional operations described in this specification can be implemented in digital electronic circuitry, or in computer software, firmware, or hardware, including the structures disclosed in this specification and their structural equivalents, or in combinations of one or more of them. Embodiments of the invention can be implemented as one or more computer program products, e.g., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Particular embodiments of the invention have been described. Other embodiments are within the scope of the following claims. For example, the steps recited in the claims can be performed in a different order and still achieve desirable results.

What is claimed is:

1. A method performed by one or more computers, the method comprising:
receiving, by the one or more computers, a workflow provided over a communication network, wherein the workflow specifies a set of one or more computer operations to be performed;
testing, by the one or more computers, the workflow by (i) performing one or more of the computer operations of the workflow and recording results of performing the one or more computer operations, and/or (ii) performing an analysis of the computer operations of the workflow;
determining, by the one or more computers, that the workflow satisfies at least one predetermined criterion for publishing workflows for use by other computer systems, wherein the determining is based on results of the testing; and
in response to determining that the workflow satisfies the at least one predetermined criterion for publishing workflows:
storing the workflow in a repository; and
publishing, by the one or more computers, the workflow to make the workflow available to one or more other computer systems.

2. The method of claim 1, wherein testing the workflow comprises:
carrying out the operations of the workflow to obtain a result; and
determining whether the result matches an expected result of the workflow.

3. The method of claim 1, wherein testing the workflow comprises:
running the workflow in a test environment;
identifying elements accessed by the operations of the workflow; and
classifying interactions with the elements.

4. The method of claim 3, comprising, based on the classifications, modifying the workflow to:
remove a portion of the workflow;
require a user confirmation when running the workflow; or
apply a flag to the workflow.

5. The method of claim 3, comprising modifying the workflow to replace one or more operations causing interactions classified as not being secure with one or more replacement operations that are determined to be secure;
wherein determining that the workflow satisfies at least one predetermined criterion comprises determining that the modified workflow satisfies the at least one predetermined criterion.

6. The method of claim 1, wherein testing the workflow comprises testing resource consumption of the workflow or stability of the workflow.

7. The method of claim 1, wherein testing the workflow comprises testing compatibility of the workflow with a plurality of software versions or system configurations.

8. The method of claim 1, wherein testing the workflow comprises testing applicability of the workflow to a plurality of different system configurations.

9. The method of claim 8, comprising, based on testing the applicability of the workflow:
identifying a reference to a resource in the workflow; and
replacing the reference to the resource with data designating a customizable field for which a value can be entered by a recipient of the workflow.

10. The method of claim 1, comprising generating, for the workflow, a set of metadata describing the workflow; and
wherein storing the workflow comprises storing the workflow in association with the generated set of metadata.

11. The method of claim 10, wherein the metadata includes a permission needed to run the workflow, a version of software that is compatible with the workflow, a result of the workflow, a data type or customization needed to use the workflow, or a security classification for the workflow.

12. The method of claim 1, wherein testing the workflow comprises:
automatically generating a plurality of computing environments that each have a different combination of software and/or settings; and
testing the workflow by monitoring execution of the operations of the workflow by each of the plurality of computing environments.

13. The method of claim 12, wherein the plurality of computing environments are cloud-computing-based virtual machines.

14. The method of claim 1, further comprising:
receiving log data indicating a set of user-initiated operations performed for a server environment;
comparing the set of user-initiated operations with the set of operations of the workflow;
determining, based on the comparison, that the set of user-initiated operations and the set of operations of the workflow have at level of similarity that satisfies a predetermined threshold; and
in response to determining that the set of user-initiated operations and the set of operations of the workflow have a level of similarity that satisfies a predetermined threshold, providing a recommendation for the workflow.

15. A system comprising:
one or more computers; and
one or more computer-readable media storing instructions that, when executed, cause the one or more computers to perform operations comprising:
receiving, by the one or more computers, a workflow provided over a communication network, wherein the workflow specifies a set of one or more computer operations to be performed;
testing, by the one or more computers, the workflow by (i) performing one or more of the computer operations of the workflow and recording results of performing the one or more computer operations, and/or (ii) performing an analysis of the computer operations of the workflow;
determining, by the one or more computers, that the workflow satisfies at least one predetermined criterion for publishing workflows for use by other computer systems, wherein the determining is based on results of the testing; and
in response to determining that the workflow satisfies the at least one predetermined criterion for publishing workflows:
storing the workflow in a repository; and
publishing, by the one or more computers, the workflow to make the workflow available to one or more other computer systems.

16. The system of claim 15, wherein testing the workflow comprises:
carrying out the operations of the workflow to obtain a result; and
determining whether the result matches a result indicated by the user providing the workflow.

17. The system of claim 15, wherein testing the workflow comprises:
running the workflow in a test environment;
identifying elements accessed by the operations of the workflow; and
classifying interactions with the elements.

18. The system of claim 17, wherein the operations comprise, based on the classifications, modifying the workflow to:
remove a portion of the workflow;
require a user confirmation when running the workflow; or
apply a flag to the workflow.

19. The system of claim 17, wherein the operations comprise modifying the workflow to replace one or more operations causing interactions classified as not being secure with one or more replacement operations that are determined to be secure;
wherein determining that the workflow satisfies at least one predetermined criterion comprises determining that the modified workflow satisfies the at least one predetermined criterion.

20. One or more non-transitory computer-readable media storing instructions that, when executed by one or more computers, cause the one or more computers to perform operations comprising:
receiving, by the one or more computers, a workflow provided over a communication network, wherein the workflow specifies a set of one or more computer operations to be performed;
testing, by the one or more computers, the workflow by (i) performing one or more of the computer operations of the workflow and recording results of performing the one or more computer operations, and/or (ii) performing an analysis of the computer operations of the workflow;
determining, by the one or more computers, that the workflow satisfies at least one predetermined criterion for publishing workflows for use by other computer systems, wherein the determining is based on results of the testing; and
in response to determining that the workflow satisfies the at least one predetermined criterion for publishing workflows:
storing the workflow in a repository; and
publishing, by the one or more computers, the workflow to make the workflow available to one or more other computer systems.
